(19) United States
(12) Patent Application Publication
(10) Pub. No.: US 2025/0363797 A1
(43) Pub. Date: Nov. 27, 2025

(54) INFORMATION PROCESSING APPARATUS, INFORMATION PROCESSING METHOD, AND PROGRAM

(71) Applicant: SONY GROUP CORPORATION, TOKYO (JP)

(72) Inventor: GUIFEN TIAN, TOKYO (JP)

(21) Appl. No.: 18/873,859

(22) PCT Filed: Apr. 27, 2023
(86) PCT No.: PCT/JP2023/016564

§ 371 Date: Dec. 11, 2024

(30) Foreign Application Priority Data
Jun. 20, 2022 (JP) 2022-098872

(51) Int. Cl. G06V 10/96; B60W 60/00; G06T 7/20; G06T 7/50; G06V 10/26; G06V 10/40; G06V 10/82; G06V 20/58

(52) U.S. Cl. CPC G06V 10/96; B60W 60/001; G06T 7/20; G06T 7/50; G06V 10/26; G06V 10/40; G06V 10/82; G06V 20/58; B60W 2420/403; B60W 2420/408; B60W 2554/4041; B60W 2554/80; G06T 2207/20084; G06T 2207/30241; G06T 2207/30261

(57) ABSTRACT

An information processing apparatus according to the present technology includes a processing section. The processing section is capable of processing a plurality of tasks for a recognition target, including first and second tasks that share a feature extraction. The processing section decides whether or not to perform the second task processing using a recognition result of the recognition target from the first task processing.

### DESCRIPTION

### Technical Field

The present technology relates to an information processing apparatus, an information processing method, and a program.

### Background Art

It is known that a plurality of cameras is mounted on a vehicle to obtain information about vehicle surroundings in order to enhance safety when driving the vehicle, etc. For example, Patent Literature 1 describes that an object with a movement is detected by performing recognition processing using images from the cameras mounted on the vehicle.

### CITATION LIST

### Patent Literature

Patent Literature 1: Japanese Patent Application Laid-open No. 2012-123470

### DISCLOSURE OF INVENTION

### Technical Problem

In order to recognize all surroundings of the vehicle with a high degree of accuracy, the similar recognition processing is always performed for the images acquired by each of the plurality of cameras mounted on the vehicle, resulting in a large overall calculation amount.

Thus, in the field of the recognition processing, there is a need for a technology that can reduce the calculation amount without degrading recognition accuracy.

In view of the circumstances as described above, an object of the present technology is to provide an information processing apparatus, an information processing method, and a program that can reduce the calculation amount without degrading the recognition accuracy.

### Solution to Problem

In order to achieve the above-mentioned object, an information processing apparatus according to an embodiment of the present technology includes a processing section.

The processing section is capable of processing a plurality of tasks for a recognition target, including first and second tasks that share a feature extraction.

The processing section decides whether or not to perform the second task processing using a recognition result of the recognition target from the first task processing.

With this configuration, since it is decided whether or not to perform the second task processing based on the recognition result from the first task processing, a calculation amount of overall recognition processing can be reduced without degrading the recognition accuracy.

The processing section may generate a parameter of the second task using the recognition result of the recognition target from the first task processing.

The processing section may configure a neural network of the second task using the parameter generated.

The processing section may extract a plurality of features from the recognition target and decide whether or not to perform the second task processing and generate the parameter using the recognition result of the recognition target from the first task processing by using the plurality of features.

The parameter may include an area to be processed for the second task and one or more features selected from the plurality of features.

The processing section may decide whether or not to perform the second task processing and generate the parameter using a scene feature obtained from the recognition result of the recognition target from the first task processing.

The recognition target may be an image acquired by an image capturing section mounted on a moving object that captures surroundings of the moving object, and

the scene feature may be a moving scene feature of the moving object, which means whether or not there is an object of interest in the image and whether or not the object of interest is a movable object.

The object of interest may be an object that is an obstacle to a movement of the moving object.

The first task may be semantic segmentation, the second task may include object detection and motion detection, and distance detection, and the processing section may only perform the distance detection if there is no object of interest in the image, perform the object detection and the distance detection if there is the object of interest in the image and the object of interest is not the movable object, and perform the object detection, the motion detection, and the distance detection if there is the object of interest in the image and the object of interest is the movable object.

The parameter may include the area to be processed for the second task and one or more features selected from the plurality of features, and

the processing section may generate the parameter if there is no object of interest in the image such that an entire image area is taken as the area to be processed and all of the plurality of features are used, and

generate the parameter if there is the object of interest in the image such that the smallest area surrounding the object of interest is taken as the area to be processed and one or more features selected from the plurality of features are used according to the number of pixels in the object of interest.

A distance measuring section may be mounted on the moving object, and

in the distance detection, a distance may be estimated using an aggregated result of aggregating the features extracted from the image and distance features obtained by the distance measuring section.

The distance measuring section may include one or more selected from LiDAR (Light Detection and Ranging), a stereo camera, and a millimeter wave radar.

The plurality of image capturing sections may be mounted on the moving object, and

the processing section may decide whether or not to perform the second task processing and generate the parameter using the image recognition result from the first task processing for each image acquired by each of the plurality of image capturing sections mounted on the moving object.

The image capturing section may be a stereo camera or a monocular camera.

The processing section may perform the second task on the image using the neural network of the second task configured by using the parameter generated, and may further include a presentation control section that controls a presentation section that provides assistance to an operator of the moving object based on a recognition result of the second task.

One or more selected from a display section, a light emission section, and a sound output section as the presentation section may be mounted on the moving object, and

the presentation control section may control at least one of display control of the display section, lighting control of the light emission section, and sound output control of the sound output section.

The moving object may be a moving object capable of moving autonomously, and

the processing section may perform the second task on the image using the neural network of the second task configured by using the parameter generated, and may further include a planning section that plans a travel and an action of the moving object based on the recognition result of the second task.

The recognition target may be an image,

the first task may be the semantic segmentation, and

the second task may include one or more selected from the object detection, the motion detection, the distance detection, normal estimation, attitude estimation, and trajectory estimation.

According to an embodiment of the present technology, an information processing method is performed by an information processing apparatus that processes a first task for a recognition target and decides whether or not to perform a second task that shares a feature extraction with the first task using a recognition result of the recognition target from the first task processing.

A program according to an embodiment of the present technology causes an information processing apparatus to perform the following steps:

a step of processing a first task for a recognition target, and

a step of deciding whether or not to perform a second task that shares a feature extraction with the first task using a recognition result of the recognition target from the first task processing.

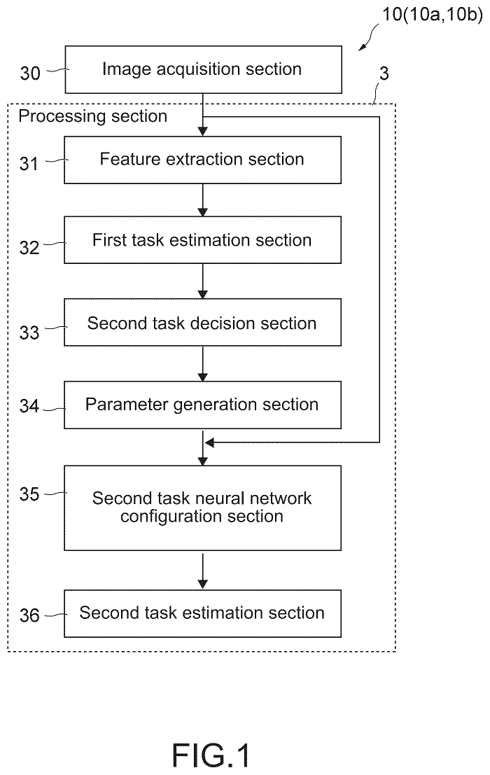

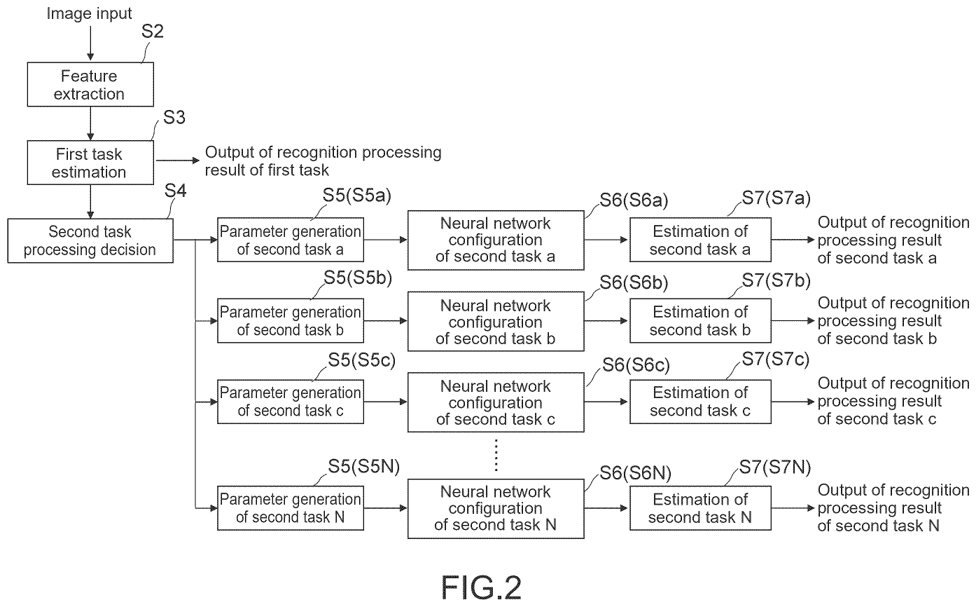

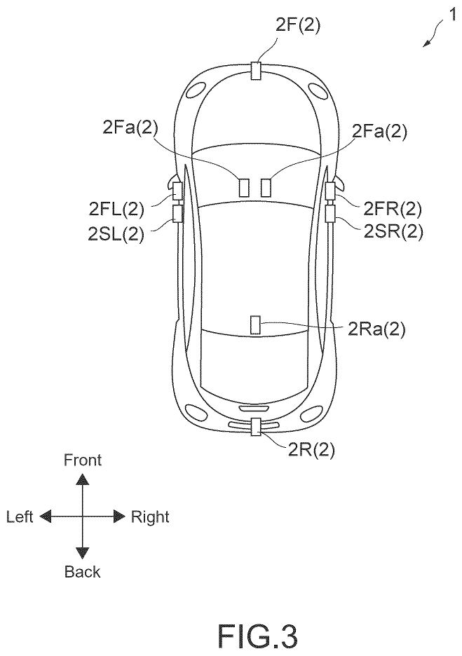

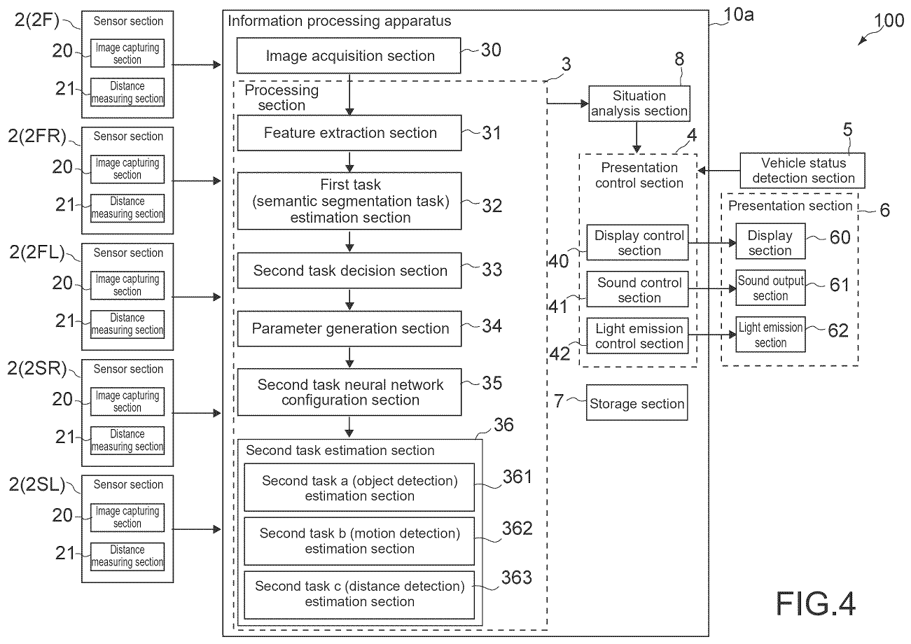

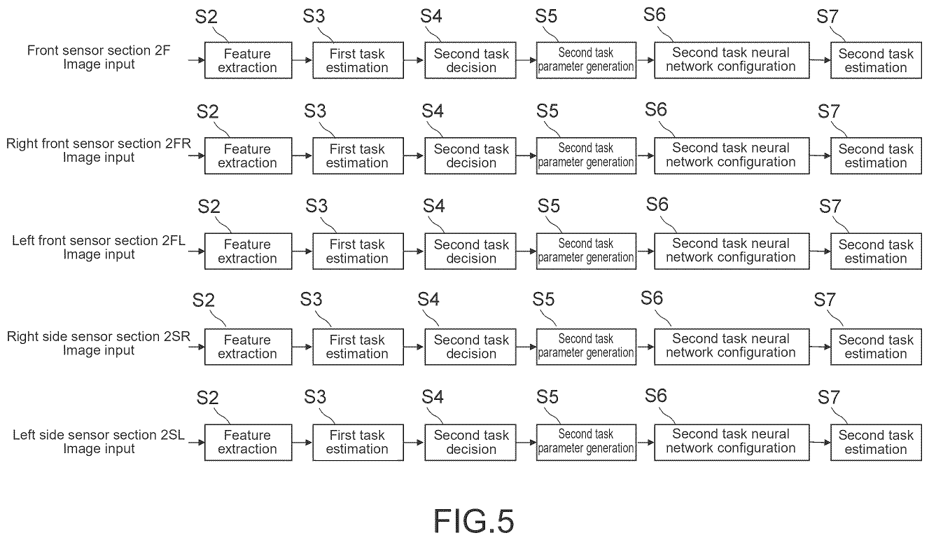

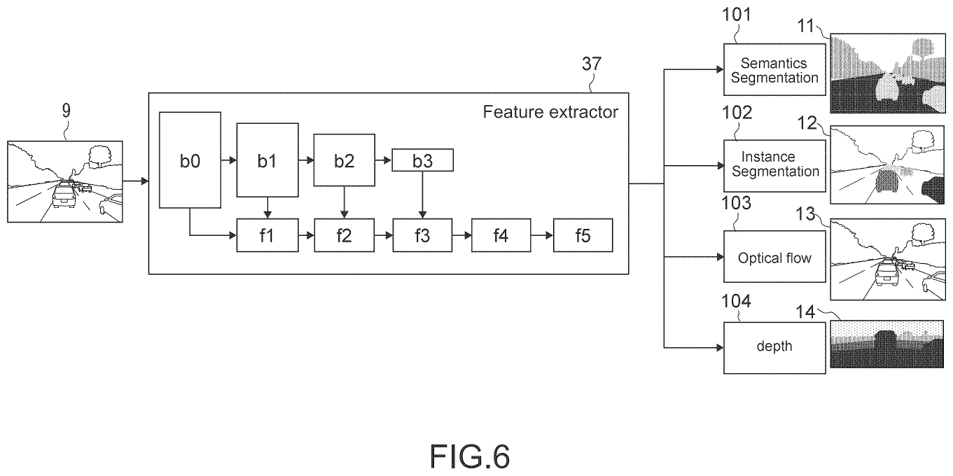

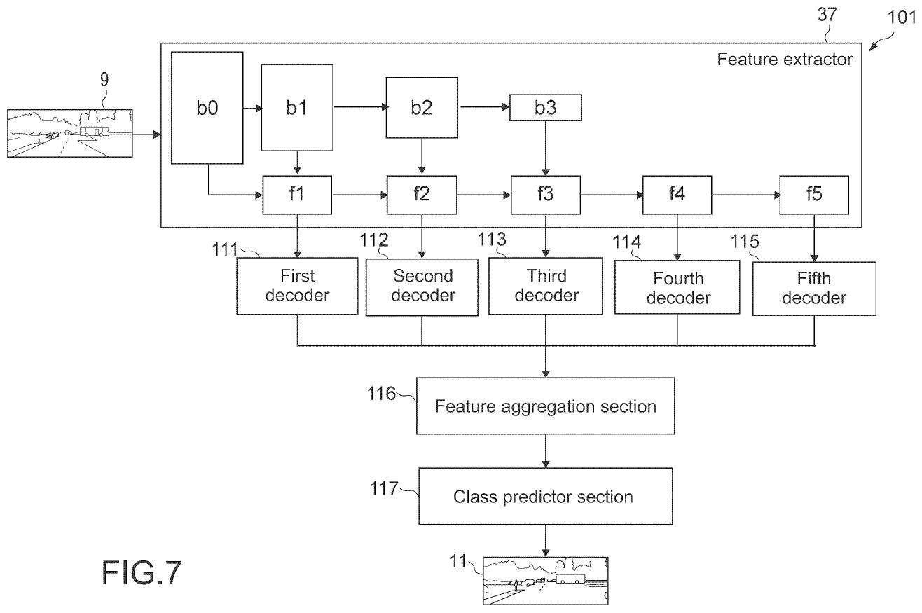

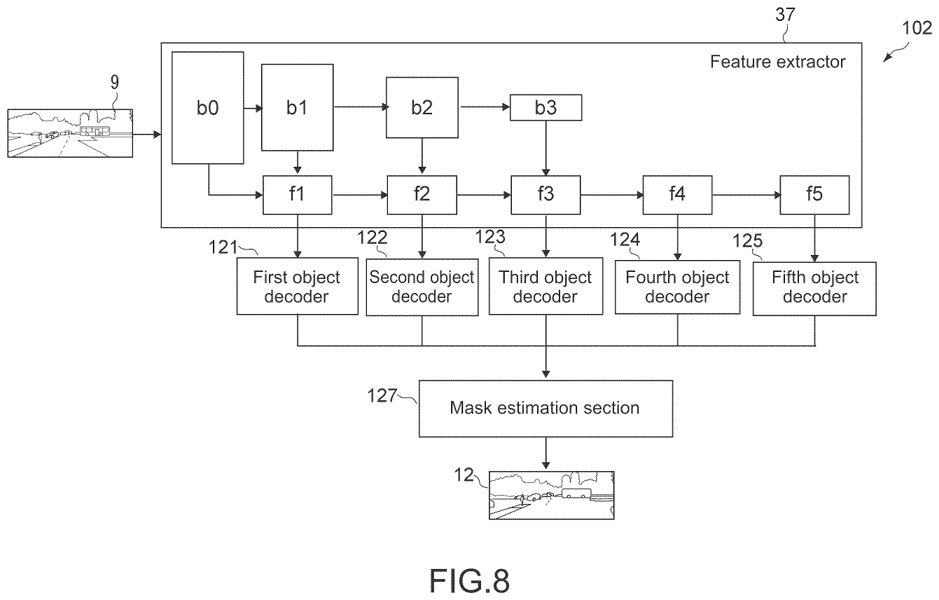

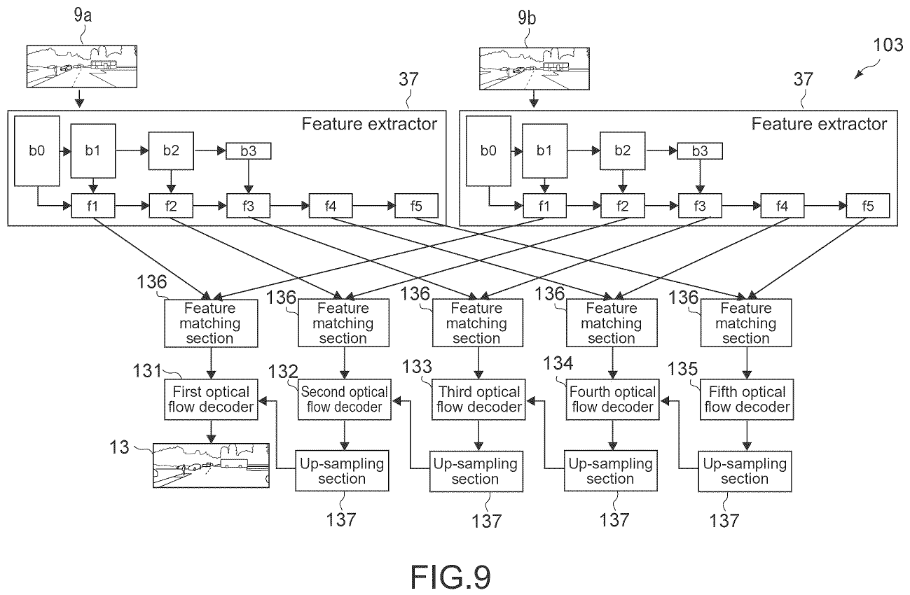

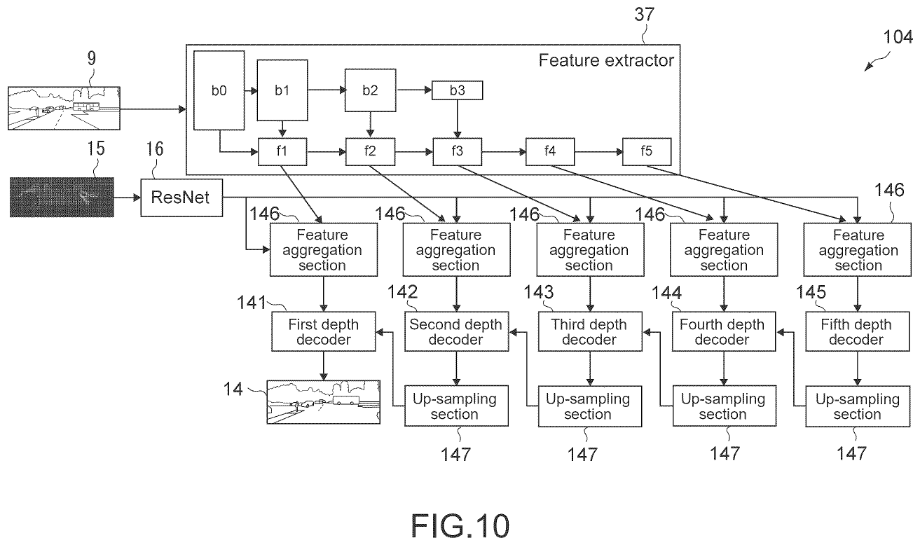

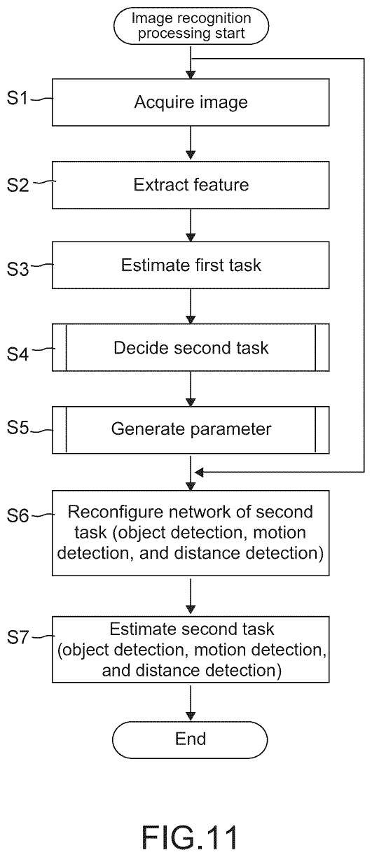

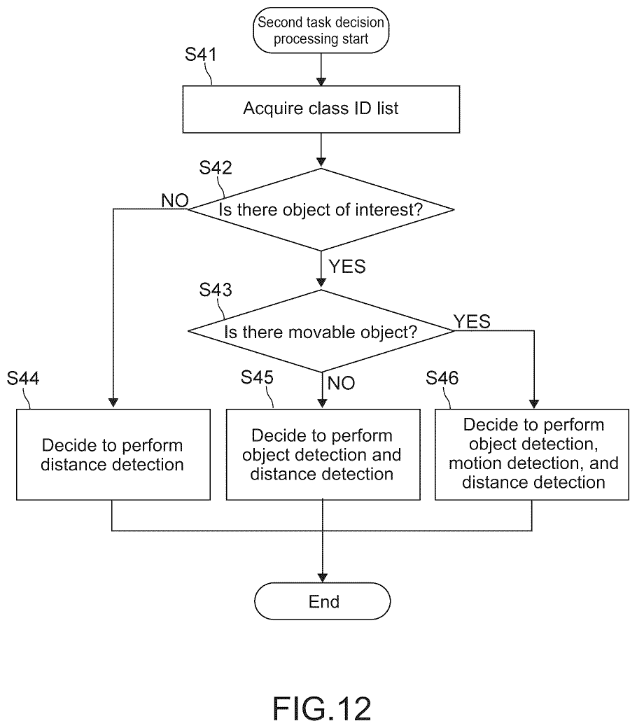

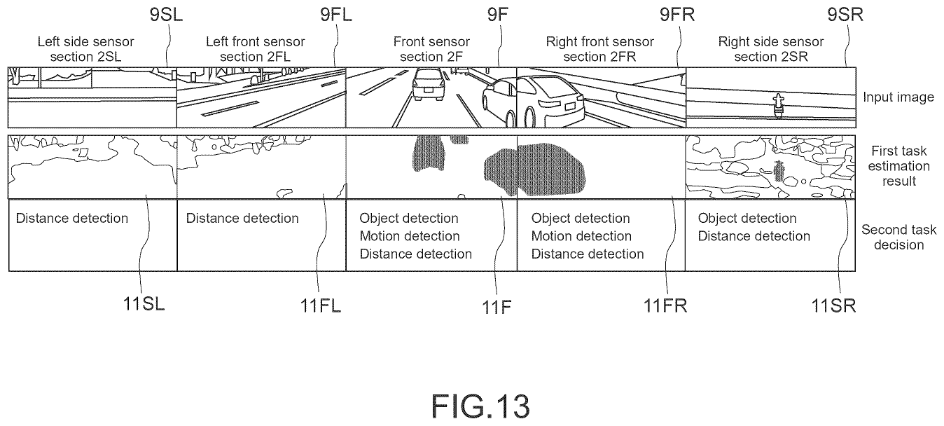

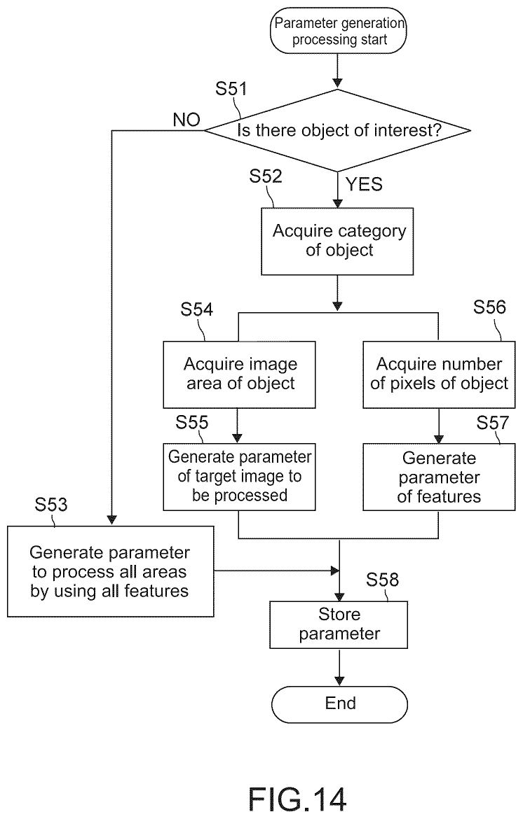

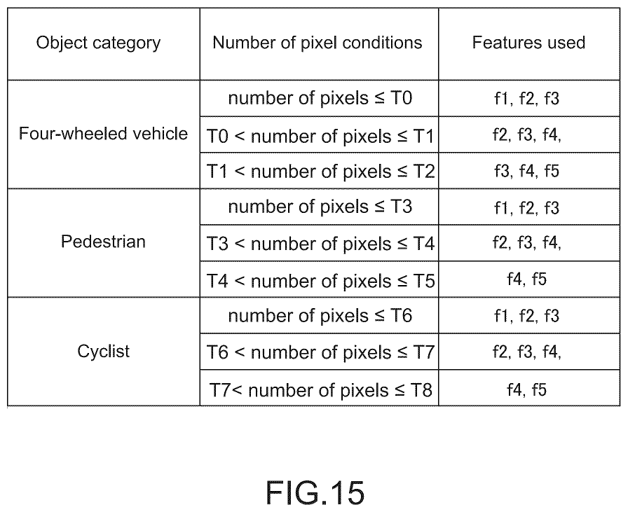

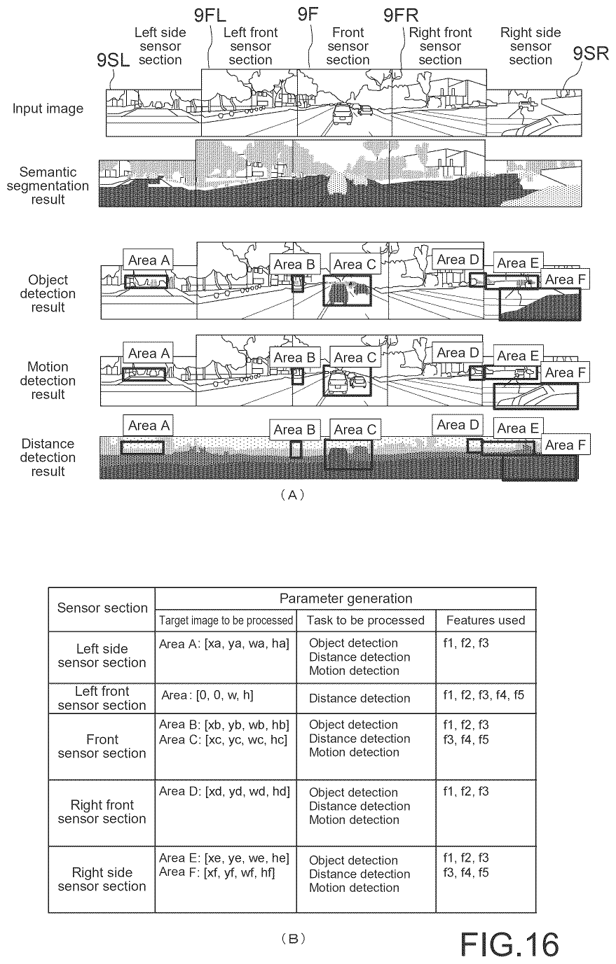

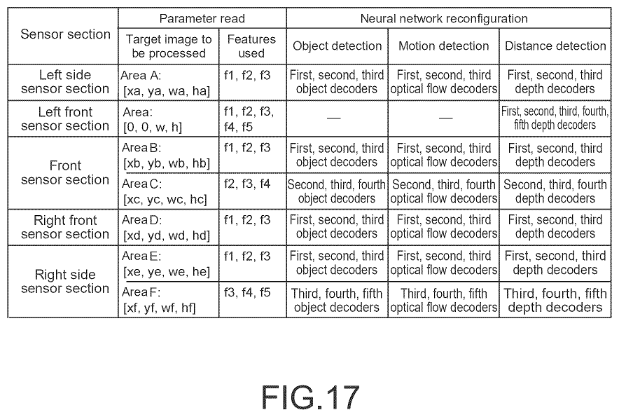

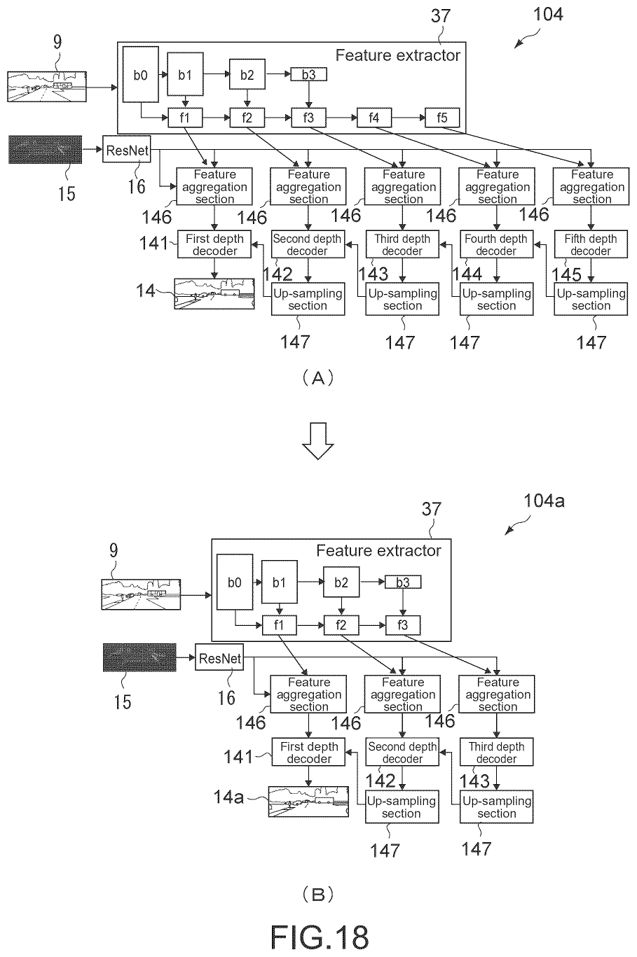

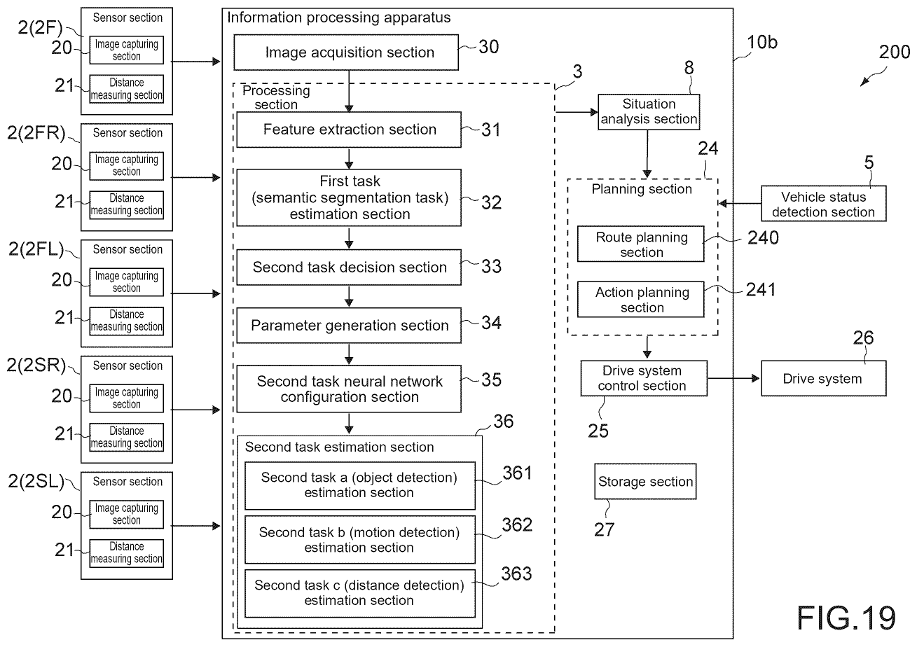

### BRIEF DESCRIPTION OF DRAWINGS

[FIG. 1] A schematic diagram showing a configuration example of a processing section of an information processing apparatus according to each embodiment of the present technology.

[FIG. 2] A flow diagram showing an image recognition processing method (information processing method) in the above processing section.

[FIG. 3] A diagram showing a top view of a vehicle and an example of a mounting location of a sensor section.

[FIG. 4] A schematic diagram showing a configuration example of an information processing system according to a second embodiment.

[FIG. 5] A flow diagram showing an image recognition processing method (information processing method) in second and third embodiments.

[FIG. 6] A schematic diagram showing a neural network of a feature extraction.

[FIG. 7] A schematic diagram showing a neural network of semantic segmentation.

[FIG. 8] A schematic diagram showing a neural network of instance segmentation (object detection).

[FIG. 9] A schematic diagram showing a neural network of an optical flow (motion detection).

[FIG. 10] A schematic diagram showing a neural network of distance detection.

[FIG. 11] A flow diagram showing an image recognition processing method (information processing method) according to each embodiment.

[FIG. 12] A flow diagram showing details of second task decision processing in Step 4 of the flow diagram of FIG. 11.

[FIG. 13] A diagram describing a specific example of the second task decision processing.

[FIG. 14] A flow diagram showing details of parameter generation processing in Step 5 of the flow diagram of FIG. 11.

[FIG. 15] A diagram showing a specific example of parameter generation.

[FIG. 16] Diagrams showing a specific example of parameter generation.

[FIG. 17] A diagram showing a configuration example of a neural network.

[FIG. 18] Diagrams showing that a calculation amount on a decoder side can be reduced by a reconfigured neural network taking distance detection as an example.

[FIG. 19] A schematic diagram showing a configuration example of an information processing system according to a third embodiment.

### MODE(S) FOR CARRYING OUT THE INVENTION

Hereinafter, each embodiment of the present technology will be described with reference to the drawings. In the following description, similar configurations will be marked with similar symbols, and descriptions of previously described configurations may be omitted. In the description of an information processing method, similar steps are numbered with similar step numbers, and descriptions of previously described steps may be omitted.

In the present technology, in recognition processing of a recognition target by an information processing apparatus capable of processing a plurality of different tasks that share a feature extraction for the recognition target, it is decided whether or not to perform remaining other tasks based on a recognition result obtained in one of the tasks. This configuration allows a calculation amount to be reduced without degrading recognition accuracy.

In the following description, an example is given in which the recognition target is an image (camera image). In first to third embodiments described below, an example is given of applying the present technology to the recognition processing of an image acquired by an image capturing section mounted on a four-wheeled vehicle (hereinafter simply referred to as “vehicle”) as a moving object. The image contains vehicle surrounding information (information outside vehicle), and a travel scene (movement scene) of the vehicle can be estimated from the image.

The first embodiment focuses on a characteristic configuration of the present technology. In the first embodiment, an overview of image recognition processing performed for a single image (hereinafter referred to as input image) is described.

In the second and third embodiments, by taking as an example in which a plurality of image capturing sections are mounted on a vehicle to sense all surroundings of the vehicle, the present technology is applied to the image recognition processing of the image acquired by each of a plurality of image capturing sections. The image recognition processing to which the present technology is applied will be described in more detail in the second embodiment.

The image recognition processing in the information processing apparatus according to each of the first, second, and third embodiments is the same. In the second embodiment, an example in given in which a driving support is provided to a driver, i.e., an operator of the vehicle, based on an image recognition processing result. In the third embodiment, an example is given in which the vehicle is capable of moving autonomously, and a vehicle travel route planning and a vehicle action planning are performed based on the image recognition processing result. An autonomous movement refers to so-called automatic driving, in which the vehicle moves autonomously without a driver's operation. Typically, the vehicle can be switched by the driver between a manual driving and an automatic driving. The term “driving” refers to a “movement of the moving object”.

In addition, it may be configured to provide both the driving support described in the second embodiment and an automatic driving control described in the third embodiment may be possible.

In the following description, “right” and “left” refer to “right” and “left” as viewed from the driver in the vehicle, “front” refers to a direction the vehicle is traveling, and “rear” refers to an opposite direction of a travel direction.

### First Embodiment

FIG. 1 is a schematic diagram showing a configuration example of a processing section 3 of an information processing apparatus 10 according to a first embodiment. FIG. 2 is a flow diagram showing an example of an image processing method (information processing method) in the processing section 3. The processing section 3 of an information processing apparatus 10aaccording to the second embodiment and the processing section 3 of an information processing apparatus 10b according to the third embodiment, which will be described below, have the same configuration as the processing section 3 of the information processing apparatus 10.

### [Information Processing Apparatus]

The information processing apparatus 10 can perform a plurality of tasks related to image recognition processing on a single image. The image is a recognition target and is acquired by an image capturing section mounted on the vehicle. Hereinafter, the image of recognition target may be referred to as an “input image”. In the information processing apparatus 10 according to this embodiment, it is possible to simultaneously process the plurality of tasks that share the same feature extraction for a single input image. In other words, the information processing apparatus 10 can perform the plurality of different task processing using a plurality of features extracted by the same feature extractor (Feature Extractor). Hereafter, the feature extractor is marked with a sign 37. Details are described in the second embodiment.

In FIG. 2, the number of tasks is set to N.

In this embodiment and the second and third embodiments described below, an example of processing four recognition tasks is given: class classification by semantic segmentation, object detection by instance segmentation, motion detection by an optical flow, and distance detection.

The plurality of tasks (four in this embodiment) that can be performed by the information processing apparatus 10 is classified as a first task and a second task. The first task and the second task are the recognition tasks, in more detail, image recognition tasks in this embodiment. The image recognition tasks can be performed for the image acquired by the image capturing section mounted on the vehicle, and a recognition processing result can be used to perform driving support presentation, the automatic driving control, etc.

The semantic segmentation (class classification) is the first task. The instance segmentation (object detection), the optical flow (motion detection) and the distance detection are the second tasks.

The semantic segmentation as the first task is the class classification. With the semantic segmentation, each pixel in the input image is classified into which object class (category) it belongs.

The instance segmentation as the second task is the object detection (also called instance detection). In the instance segmentation, an object in the input image is detected. In the following description, it is primarily referred to as the “object detection.

The optical flow as the second task is the motion detection. In the optical flow, motion of the object in the input image is detected. Specifically, in the optical flow, motion of an object of interest between two input image frames in a continuous manner in time is estimated. In the following description, it is primarily referred to as the “motion detection.”

In the distance detection as the second task, a distance between the object and the vehicle (vehicle on which image capturing section is mounted) is estimated using features extracted by the feature extractor 37 and a LiDAR point cloud acquired by LiDAR (Light Detection and Ranging) as a distance measuring section (described below).

Details of each task processing will be described in the second embodiment described below.

In the image recognition processing by the processing section 3 of the information processing apparatus 10, based on the recognition result obtained from the semantic segmentation (first task), it decides whether or not to perform the remaining other tasks (second tasks), namely, the object detection (instance segmentation), the motion detection (optical flow), and the distance detection, respectively. This configuration reduces the calculation amount. A specific example is described in the second embodiment.

As shown in FIG. 1, the information processing apparatus 10 has an image acquisition section 30 and the processing section 3. The processing section 3 has a feature extraction section 31, a first task estimation section 32, a second task decision section 33, a parameter generation section 34, a second task neural network configuration section 35, and a second task estimation section 36.

The image acquisition section 30 acquires an image (input image) acquired by the image capturing section.

The feature extraction section 31 extracts a plurality of common features of the plurality of tasks (first task and second task) from the input image. The feature extraction section 31 includes the feature extractor 37 (see, for example, FIG. 6, etc.).

The first task estimation section 32 performs the semantic segmentation on the input image using deep learning and the class classification of the object on a pixel-by-pixel basis.

A scene feature of the input image can be estimated from a semantic segmentation result (input image recognition result from first task processing). For example, a driving scene feature (moving scene feature) can be obtained from the semantic segmentation result. Hereinafter, the “driving scene feature” is simply referred to as the “scene feature”.

The scene feature indicates whether or not there is an object that is an obstacle to driving and whether or not the object is a movable object. Hereinafter, the “object that is the obstacle to driving” may be referred to as the “object of interest”.

The object that is the obstacle to driving is, for example, the vehicle such as an automobile, a motorcycle, a bicycle, and a train, a utility pole, a traffic signal, a trash can, a pole, a human, an animal, and so on. On the other hand, an object that is not the obstacle to driving is, for example, a road surface, sky, and so on.

The object that is the obstacle to driving can be further classified into a movable object and an immovable object (so-called a stationary object). The movable object is, for example, the vehicle, the human, the animal, and so on.

The second task decision section 33 decides whether or not to perform the second tasks, i.e., the object detection, the motion detection, and the distance detection, respectively, based on the semantic segmentation result. Based on the scene feature obtained from the semantic segmentation result, the second task decision section 33 decides the second task to be performed in order to obtain the image recognition processing result necessary for acquiring information required for the automatic driving or the driving support.

The second task decision section 33 decides not to perform the object detection and the motion detection, but to perform only the distance detection, if there is no object of interest (object that that is the obstacle to driving) in the input image.

The second task decision section 33 decides not to perform the motion detection but to perform only the object detection and the distance detection, if there is the object of interest in the input image but no movable object.

The second task decision section 33 decides to perform all the second tasks of the object detection, the motion detection, and the distance detection, if there is a movable object of interest.

Thus, the calculation amount of the recognition processing can be reduced without degrading the recognition accuracy since the second task (image recognition task) to be performed is decided according to the scene feature obtained from the semantic segmentation result, so that the necessary image recognition processing result is obtained.

The parameter generation section 34 uses the semantic segmentation result to dynamically generate a parameter of the second task decided to be performed. The parameter of the second task includes a target image to be processed for performing the second task and the features to be used when performing the second task. The target image to be processed is the smallest rectangular image area that contains the object of interest (described below). The features to be used when performing the second task are decided according to the number of pixels of the object of interest.

From the semantic segmentation result, the category of the object of interest and the image area in which the object of interest resides can be ascertained.

The parameter generation section 34 uses the semantic segmentation result in the object detection to generate the parameter of the object detection, so that a partial neural network corresponding to the number of pixels and the object category in the image area where the object of interest resides is processed.

The parameter generation section 34 generates a parameter of the distance detection, so that, if there is the object of interest in the distance detection, only the image area that includes the object of interest (image to be processed) is processed, and the partial neural network is processed according to the number of pixels of the object of interest.

On the other hand, the parameter generation section 34 generates the parameter of the distance detection so that, if there is no object of interest in the distance detection, the entire input image is processed and all the features are used.

The parameter generation section 34 generates a parameter of the motion detection so that, if there is the movable object of interest in the motion detection, only the image area that includes the movable object of interest (image to be processed) is processed, and the partial neural network is processed according to the number of pixels of the object of interest.

The second task neural network configuration section 35 uses the parameter generated by the parameter generation section 34 to configure the neural networks for each of the second tasks: the object detection, the motion detection, and the distance detection.

If all the features f1 to f5 are generated as the parameters by the parameter generation section 34, the second task neural network configuration section 35 uses a standard neural network as the neural network to be used for the second task processing. In the embodiment, the “standard neural network” refers to the neural network that is configured to use all the features f1 to f5, each of which is shown in FIGS. 7 to 9, respectively, described below.

The second task estimation section 36 uses the neural network of the configured object detection to perform the object detection (instance segmentation).

The second task estimation section 36 uses the neural network of the configured distance detection to perform the distance detection and estimates the distance.

The second task estimation section 36 uses the neural network of the configured motion detection to perform the motion detection (optical flow) and estimate the motion of the object.

The information processing apparatus 10 has a hardware configuration necessary for a computer, for example, a central processing section (CPU) and a memory (RAM, ROM). In the information processing apparatus 10, the CPU loads a program stored in a storage section (not shown) into a RAM and performs it to perform various processes. The storage section stores a program for performing the image recognition processing according to this embodiment.

### [Information Processing Method (Image Recognition Processing Method)]

FIG. 2 is used to describe the information processing method (image recognition processing method) performed in the processing section 3 of the information processing apparatus 10 of this embodiment. In FIG. 2, the plurality of second tasks that differ from each other are shown as a second task a, a second task b, a second task c . . . and a second task N. N corresponds to the number of the second tasks. For example, in FIG. 2, the second task a indicates the object detection (instance segmentation), the second task b indicates the motion detection (optical flow), and the second task c indicates the distance detection. The number of second tasks is not limited and may be one or more.

As shown in FIG. 2, when the image is input to the processing section 3, the plurality of features of the input image are extracted by the feature extraction section 31 (S2).

Next, the first task (semantic segmentation in this embodiment) is performed by the first task estimation section 32 using the plurality of features extracted in S2 (S3). The semantic segmentation result (first task processing result) is output to the second task decision section 33. The semantic segmentation result can be used to estimate the scene feature of the input image.

Next, the second task decision section 33 decides whether or not to perform the second tasks a, b, c to N, respectively, using the semantic segmentation result (S4). In this embodiment, the second task decision section 33 decides whether or not to perform the object detection, the motion detection, and the distance detection, respectively. If there are other second tasks, it is also decided whether or not to perform the second tasks.

Next, the parameter of the second task is generated by the parameter generation section 34 (S5).

In FIG. 2, a step of parameter generation that generates the parameter of the second task a (object detection) is denoted as S5a. A step of parameter generation that generates the parameter of the second task b (motion detection) is denoted as S5b. A step of parameter generation that generates the parameter of the second task c (distance detection) is denoted as S5c. A step of parameter generation that generates the parameter of the second task N is denoted as S5N. These S5a, S5b, S5c. . . . S5N are denoted as S5 if there is no need to distinguish between them.

In this embodiment, the parameter of the second task a (S5a) is generated using the semantic segmentation result, as shown in FIG. 2. The parameter of the second task b (S5b) is generated using the semantic segmentation result. The parameter of the second task c (S5c) is generated using the semantic segmentation result. The parameter of the second task N (S5N) is generated using the semantic segmentation result.

Next, the neural network of the second task is configured by the second task neural network configuration section 35 using the parameter generated in S5 (S6).

The neural network configured here is the standard neural network, or the neural network reconfigured so that only a part of the features is used.

In FIG. 2, a step of configuring the neural network of the second task a is denoted as S6a. A step of configuring the neural network of the second task b is denoted as S6b. A step of configuring the neural network of the second task c is denoted as S6c. A step of configuring the neural network of the second task N as S6N. These S6a, S6b, S6c. . . . SON are denoted as S6 if there is no need to distinguish between them.

In this embodiment, as shown in FIG. 2, the neural network of the second task a is configured using the parameter generated in S5a (S6a). The neural network of the second task b is configured using the parameter generated in S5b (S6b). The neural network of the second task c is configured using the parameter generated in S5c (S6c). The neural network of the second task b is configured using the parameter generated in S5N (S6N).

Next, the second task is performed by the second task estimation section 36 using the neural network configured in S6 (S7).

In FIG. 2, a step of estimation using the neural network of the configured second task a is denoted as S7a. The step of estimation using the neural network of the configured second task b is denoted as S7b. The step of estimation using the neural network of the configured second task c is denoted as S7c. The step of estimation using the neural network of the configured second task n is denoted as S7n. These S7a, S7b, S7c . . . S7N are denoted as S7 if there is no need to distinguish between them.

In this embodiment, the instance segmentation is performed (S7a) using the neural network of the second task a (object detection) configured as shown in FIG. 2, and an object detection result (recognition processing result of second task a) are output.

Using the neural network of the configured second task b (motion detection), the optical flow is performed (S7b), and a motion detection result (recognition processing result of second task b) is output.

Using the neural network of the configured second task c (distance detection), the distance detection is performed (S7c), and a distance detection result (recognition processing result of second task c) is output.

By using the output recognition processing result (semantic segmentation result, object detection result, motion detection result, and distance detection result), the driving support (described in detail in the second embodiment) and the automatic driving (described in detail in the third embodiment) can be made highly accurate while reducing power consumption.

In this embodiment and the second and third embodiments described below, an example in which the processing section performs four task processing is given, but the number of tasks is not limited to four, but may be two or more, and may include one first task and one or more second tasks.

A processing result of the first task is used to decide whether or not to perform other second tasks. The first task is essential for deciding whether or not to perform other second tasks. In the image recognition processing, as the first task, the semantic segmentation is typically used.

There may be one or more second tasks. Whether or not the second task is performed is decided based on the processing result of the first task. In the image processing using the present technology, one or more tasks selected from the object detection (instance segmentation), the motion detection (optical flow), the distance detection, the normal (Normal) estimation, pose (Pose) estimation, the trajectory (Trajectory) estimation, etc. can be used as the second task.

In the first to three embodiments, the second task is an example of three tasks: the object detection (instance segmentation), the motion detection (optical flow), and the distance detection.

As described above, in the present technology, the second task to be performed is decided according to the semantic segmentation result (recognition result of recognition target by first task processing), and the parameter of the second task is further generated. Then, the neural network of the second task is configured using the parameter generated, and the image recognition task is performed using the configured neural network.

Since the present technology decides the second task to be performed using the semantic segmentation result, only the recognition tasks necessary for the image recognition can be performed, and the calculation amount of overall recognition processing can be reduced without degrading the recognition accuracy.

Furthermore, in the present technology, the neural network is configured of the parameter generated using the semantic segmentation result, making it possible to process only the partial network according to scene feature, thereby further reducing the calculation amount of the recognition processing while maintaining high recognition accuracy.

This enables a reduction in the power consumption and a processing delay to be suppressed, and a real-time recognition processing result with the high recognition accuracy can be obtained. The recognition processing result can then be used to provide the driving support and the automatic driving control with high accuracy at precise timing.

The present technology is also very effective in reducing the calculation amount in a system that performs real-time image recognition processing for each of the plurality of images, as in the second and third embodiments described below.

For example, for an all-surroundings sensing system in which the plurality of image capturing sections is mounted on the vehicle to acquire the vehicle surrounding information over a wide area, if four recognition tasks are always performed for each image acquired by each image capturing section, the calculation amount becomes enormous. However, by applying the image recognition processing method (information processing method) of the present technology to each image acquired by each image capturing section, the calculation amount of the overall recognition processing can be reduced while maintaining the high recognition accuracy. This makes it possible to reduce the power consumption and the processing delay in a form such as the all-surroundings sensing system, which requires the image recognition processing of a plurality of images in real time, and enables the driving support and the automatic driving control with high accuracy at the precise timing.

### Second Embodiment

In the second embodiment, the technology described in the first embodiment is applied to the image recognition processing of each image acquired by each of the plurality of image capturing sections mounted on the vehicle, and the image recognition processing result is used for the driving support.

### [Vehicle Example]

FIG. 3 is a top view of a vehicle and shows an example of locations of the plurality of sensor sections 2 mounted on the vehicle. As will be described in detail below, each sensor 2 has an image capturing section 20 and a distance measuring section 21. The locations of the sensor sections 2 shown in FIG. 3 are only an example and are not limited to this. If there is no need to distinguish between the plurality of sensor sections 2, they are referred to as the sensor sections 2.

As shown in FIG. 3, for example, a front sensor section 2F, two front sensor sections 2Fa, a right front sensor section 2FR, a left front sensor section 2FL, a right side sensor section 2SR, a left side sensor section 2SL, a rear sensor section 2R and a rear sensor section 2Ra are mounted on the vehicle 1. Any of the sensor sections is capable of acquiring the vehicle surrounding information.

The front sensor section 2F is located near a front bumper and acquires the vehicle surrounding information in front of the vehicle.

The two front sensor sections 2Fa are located in front of a roof to acquire the vehicle surrounding information in front of the vehicle.

The right front sensor section 2FR is located in front of a right side of the vehicle and acquires the vehicle surrounding information diagonally front of the right of the vehicle.

The left front sensor section 2FL is located in front of a left side of the vehicle and acquires the vehicle surrounding information diagonally front of the left of the vehicle.

The right side sensor section 2SR is located behind the right front sensor section 2FR and acquires the vehicle surrounding information at the right side of the vehicle.

The left side sensor section 2SL is located behind the left front sensor section 2FL and acquires the vehicle surrounding information at the left side of the vehicle.

The rear sensor section 2R is located near a rear bumper and acquires the vehicle surrounding information behind the vehicle.

The rear sensor section 2Ra is located behind the roof and acquires the vehicle surrounding information behind the vehicle.

In the second and third embodiments, for convenience, an example is shown in which the present technology is applied to the recognition processing of sensing result (image) from the image capturing section 20 of each of the five sensor sections: the front sensor section 2F, the right front sensor section 2FR, the left front sensor section 2FL, the right side sensor section 2SR, and the left side sensor section 2SL. The number of sensor sections 2 to which the present technology is applied is not limited to this, and one or more thereof is sufficient.

### [Information Processing System]

FIG. 4 is a schematic diagram of an information processing system 100 according to this embodiment. In the information processing system 100, driving support processing is performed using the image recognition processing result of the acquired image of the plurality of image capturing sections 20 mounted on the vehicle 1. The information processing system 100 in this embodiment can be rephrased as a driving support system.

As shown in FIG. 4, the information processing system 100 has the plurality of sensor sections 2, an information processing apparatus 10a, a vehicle status detection section 5, and a presentation section 6. All of these are mounted on the vehicle 1.

### (Sensor Section)

Each sensor section 2 includes the image capturing section 20 and the distance measuring section 21.

The image capturing section 20 acquires the image and is configured of a CMOS sensor, for example. The image capturing section 20 in this embodiment acquires the image of the surroundings of the vehicle 1. A monocular camera, a stereo camera, or the like can be used for the image capturing section 20.

The distance measuring section 21 is configured to be capable of measuring the distance between the vehicle 1 on which the image capturing section 20 is mounted and the object around the vehicle 1. As the distance measuring section 21, the LiDAR, the stereo camera, the millimeter wave radar, etc. can be used, and the distance measuring section 21 is configured to include one or more selected from these. In this embodiment, an example is given in which the LiDAR is used as the distance measuring section 21.

The image acquired by the image capturing section 20 of the sensor section 2 and 3D point cloud information acquired by the LiDAR as the distance measuring section 21 are output to the information processing apparatus 10a.

In each of the sensor sections 2, the image capturing section 20 and the distance measuring section 21 are typically located in close proximity to each other. Since the camera (image capturing section) and the LiDAR (distance measuring section) are generally mounted at different locations, correspondence information between a camera coordinate system with a camera location as an origin and a LiDAR coordinate system with a LiDAR location as an origin is obtained and stored in advance. Using this correspondence information, the image recognition processing related to the distance detection can be performed by associating the image acquired by the camera with the 3D point cloud acquired by the LiDAR.

### (Presentation Section)

The presentation section 6 includes a device capable of outputting and presenting visual or auditory information to the driver of the vehicle 1. The presentation section 6 is mounted on the vehicle 1. The presentation section 6 can present information related to the driving support to the driver of the vehicle 1, such as reporting the vehicle surrounding information, encouraging caution and warning, and suggesting a preferred speed and travel route.

The presentation section 6 includes, for example, a display section 60, a sound output section 61, and a light emission section 62. The driving support may be provided using one or more selected from the display section 60, the sound output section 61, and the light emission section 62. Driving support information is visually presented to the driver by display on the display section 60 and by lighting or blinking on the light emission section 62. The driving support information is presented auditory to the driver by sound output in the sound output section 61.

The presentation of visual or auditory driving support information to the driver by the presentation section 6 is performed using the image recognition processing result in the processing section 3 of the image acquired in the sensor section 2.

The driving support information is, for example, effective information for preventing an accident or the like when driving the vehicle. Examples of the driving support include obstacle warning, own vehicle collision warning, own vehicle lane departure warning, a driving operation order, a speed change orders, a vehicle overtaking recommendation, a lane change recommendation, and notification of travel condition information. The driver can drive more safely based on the driving support information presented by the presentation section 6.

The display section 60 displays the visual information in the driver's field of vision. The display section 60 includes, for example, a display device, an instrument panel, a wearable device such as a glass-type display worn by the driver, or a projector. The display section 60 displays under control of the presentation control section 4 described below.

The sound output section 61 includes a speaker, an alarm, a buzzer, etc., for example. The sound output section 61 outputs the sound information, a notification sound, a warning sound, etc. under the control of the presentation control section 4 described below.

The light emission section 62 includes a light emission device such as, for example, a lamp. The light emission section 62 can function, for example, as a warning light, and the light emission section 62 turns on or blinks light for the purpose of notifying or warning the driver of various information under the control of the presentation control section 4 described below.

### (Vehicle Condition Detection Section)

The vehicle status detection section 5 detects a status of the vehicle. For example, the vehicle status detection section 5 includes a gyro sensor, an acceleration sensor, and sensors for detecting an amount of operation of an accelerator pedal, an amount of operation of a brake pedal, a steering angle, an engine rotation speed, a motor rotation speed, or a vehicle rotation speed. Vehicle information detected by the vehicle status detection section 5, such as the speed and the steering angle of the vehicle 1, is output to the presentation control section 4 described below.

### (Information Processing Apparatus)

The information processing apparatus 10a has a hardware configuration necessary for a computer, for example, a CPU and a memory (RAM, ROM). In the information processing apparatus 10a, the CPU loads a program stored in a storage section 7 (described below) into the RAM and performs it to perform various processes, including the image recognition processing according to the present technology.

In the information processing apparatus 10a, the semantic segmentation (first task) is performed for each input image from the image capturing section 20 of each of the plurality of sensor sections 2. The semantic segmentation result is used to decide the task (second task) to be used for the image recognition processing, and the parameter of that task is generated.

The information processing apparatus 10a includes the processing section 3, the image acquisition section 30, the presentation control section 4, the storage section 7, and a situation analysis section 8.

### ((Image Acquisition Section))

The image acquisition section 30 acquires the image acquired by the image capturing section 20 of each sensor section 2. The image is output to the processing section 3.

### ((Processing Section))

The processing section 3 performs the recognition processing of the image (input image) acquired by the image acquisition section 30. At this time, as described in the first embodiment, the processing section 3 uses the result of performing the first task made for the input image to decide whether or not to perform the second task and to generate the parameter of the second task.

Also in this embodiment, as in the first embodiment, an example is described in which the first task is the semantic segmentation and the second tasks are the object detection (instance segmentation), the motion detection (optical flow), and the distance detection. In FIG. 4, in order to distinguish these second tasks, the object detection is referred to as the second task a, the motion detection is referred to as the second task b, and the distance detection is referred to as the second task c.

Hereinafter, it will be described in detail.

The processing section 3 includes the feature extraction section 31, the first task estimation section 32, the second task decision section 33, the parameter generation section 34, the second task neural network configuration section 35, and the second task estimation section 36.

The feature extraction section 31 extracts the plurality of features of the input image by means of the feature extractor 37. The feature extraction is described in detail below.

The first task estimation section 32 performs the semantic segmentation as the first task. The semantic segmentation result is output to the second task decision section 33 and the situation analysis section 8. The semantic segmentation is described in detail below.

The second task decision section 33 decides whether or not to perform the second task a, the second task b, and the second task c, respectively, based on the semantic segmentation result. The specific second task decision is described below.

The parameter generation section 34 generates the parameter of performing the second task decided to be performed based on the semantic segmentation result. The parameter generated is stored in the storage section 7. Specific parameter generation is described below.

The second task neural network configuration section 35 reads the parameter generated by the parameter generation section 34 from the storage section 7 and configures the neural network of the second task using the parameter.

The second task estimation section 36 performs the second task processing using the configured neural network. A second task processing result (input image recognition result) is output to the situation analysis section 8.

The second task estimation section 36 has a second task a estimation section 361, a second task b estimation section 362, and a second task c estimation section 363. The second task a estimation section 361 performs the instance segmentation and detects the object. The second task b estimation section 362 performs the optical flow and detects the motion of the object. The second task c estimation section 363 performs the distance detection. The object detection, the motion detection and the distance detection will be described in detail below.

FIG. 5 is a schematic flow diagram showing an example of the image recognition processing of the image acquired by each of the plurality of sensor sections 2 mounted on the vehicle 1 in the second and third embodiments, performed by the processing section 3.

As shown in FIG. 5, the image recognition processing (information processing) of the present technology is applied to the image acquired by each of five sensor sections: the front sensor section 2F, the right front sensor section 2FR, the left front sensor section 2FL, the right side sensor section 2SR, and the left side sensor section 2SL. In other words, in the processing section 3, the processes S1 to S6 described in the first embodiment are performed for each of the input images from the plurality of sensor sections 2.

In the image recognition processing for each of the images acquired by the plurality of sensor sections 2, it decides whether or not to perform the second task, which is another task, based on the recognition processing result of the first task. This allows the calculation amount of the overall recognition processing to be reduced without degrading the recognition accuracy, thereby reducing the power consumption and the processing delay.

### ((Situation Analysis Section))

The situation analysis section 8 performs analysis processing of a surrounding situation of the vehicle based on the recognition processing result of the first task (semantic segmentation result) and the recognition processing result of the second task (one or more processing results selected from object detection result, motion detection result, and distance detection result). An analysis result is output to the presentation control section 4.

### ((Presentation Control Section))

The presentation control section 4 generates the driving support information using the analysis result output from the situation analysis section 8 and status information of the vehicle 1 detected by the vehicle status detection section 5, and controls the presentation section 6 that presents the driving support information.

The presentation control section 4 has, for example, a display control section 40, a sound control section 41, and a light emission control section 42.

The display control section 40 controls the display on the display section 60.

The sound control section 41 controls the sound output at the sound output section 61.

The light emission control section 42 controls the lighting of the light emission section 62.

The analysis result by the situation analysis section 8 described above is generated using the image recognition processing result in the processing section 3. As described above, since the processing section 3 can perform the image recognition processing that maintains the high recognition accuracy while reducing the calculation amount, the analysis result of the surrounding situation of the vehicle performed using the highly accurate image recognition processing result is highly accurate information. The driving support information generated using such highly accurate information is appropriate for the situation of the vehicle 1, and the driver can drive more safely using the driving support information.

In addition, the processing section 3 of the information processing apparatus 10a of the present technology can reduce the calculation amount of the image recognition processing, thereby suppressing the processing delay and enabling the presentation of accurate driving support information at the precise timing.

### ((Storage Section))

The storage section 7 stores various programs and data necessary for processing in the information processing apparatus 10a. For example, the storage section 7 stores the program for performing a series of processes according to the image recognition processing performed in the processing section 3 of the present technology. For example, the storage section 7 stores various parameters used in the processing according to the image recognition processing and logs relating to the vehicle travel, etc. For example, the storage section 7 stores the program for performing a series of processes performed by the situation analysis section 8 and the presentation control section 4.

The storage section 7 includes, for example, a magnetic storage device such as the ROM (Read Only Memory), the RAM (Random Access Memory), and an HDD (Hard Disc Drive), a semiconductor storage device, an optical storage device, and a magneto-optical storage device.

### [Feature Extraction]

The feature extraction by the feature extraction section 31 is described below.

FIG. 6 is a schematic diagram showing a configuration of the image recognition processing by the processing section 3 of the information processing apparatus 10a, and is a schematic diagram showing a neural network of the feature extraction.

As shown in FIG. 6, the plurality of features f1 to f5 common to the four tasks are extracted from the input image 9 acquired by the sensor section 2 by the feature extractor (Feature Extractor) 37 that constitutes the feature extraction section 31. As the common features for the four tasks, a color feature and an edge feature of the input image are extracted by the feature extractor 37 of the neural network.

By the feature extractor 37, basic feature maps b0, b1, b2, and b3 with different resolutions are obtained from the input image 9 using processing on a combined layer of a plurality of mutually different convolutional operations and activation functions.

The basic feature maps b0 and b1 of the layers closer to the input image have relatively a high resolution and have detailed structural information of the image. On the other hand, the basic feature maps b2 and b3 of the layers farther from the input image have a relatively low resolution and have rough structural information of the image.

Furthermore, the features f1 to f5 are extracted from the two adjacent basic feature maps by the convolution operation. The features f1 to f5 are the final feature maps, and are referred to herein as “features” to distinguish them from the basic feature maps.

For example, using the basic feature maps b0 and b1, the feature f1 is extracted by the convolution operation. Using the basic feature map b2 and the feature f1, the feature f2 is extracted by the convolution operation. Using the basic feature map b3 and feature f2, the feature f3 is extracted by the convolution operation. Using the feature f3, the feature f4 is extracted by the convolution operation. Using the feature f4, the feature f5 is extracted by the convolution operation.

The features f1 and f2 have a relatively higher resolution and more detailed color and edge information, while the features f3 to f5 have a relatively lower resolution but wider edge information. The resolutions of the features become lower from f1, f2, f3, f4, to f5.

The feature extractor 37 learns a sum of loss functions of the four tasks: the semantic segmentation, the object detection (instance segmentation), the motion detection (optical flow), and the distance (depth) detection, and minimizes the loss functions of all tasks so as to extract the common features f1 to f5 of the four tasks.

The information processing apparatus 10a can perform the four task processing of the semantic segmentation, the object detection, the motion detection, and the distance detection using the extracted features f1 to f5.

As shown in FIG. 6, the semantic segmentation yields a semantic segmentation result 11 as the image recognition processing result. The semantic segmentation result 11 is an image in which the label or the category is associated with all pixels in the image.

The object detection (instance segmentation) yields an object detection result 12 as the image recognition processing result.

The motion detection (optical flow) yields an optical flow result 13 as the image recognition processing result.

The distance detection yields a distance detection result 14 as the image recognition processing result.

### [Semantic Segmentation (Classification)]

FIG. 7 is a schematic diagram showing a neural network 101 for the semantic segmentation. The first task estimation section 32 performs the semantic segmentation using the neural network 101 for the semantic segmentation (first task).

The first task estimation section 32 performs the semantic segmentation and divides the input image 9 into areas such as the road surface, a sidewalk, the sky, a pedestrian, the vehicle, a cyclist, a building, a curb, a plant, a guardrail, the utility pole, a sign, the traffic signal, an animal, the trash can, the pole, etc., on a pixel-by-pixel basis.

In the semantic segmentation, N classes from 1 to N are defined in advance, probability of each class 1 to N is estimated for each pixel, and the class with the highest probability is an estimated class for that pixel. Each class is assigned a class ID. In more detail, the estimation is done as follows.

As shown in FIG. 7, each of the features f1 to f5 of the input image 9 output from the feature extractor 37 is output to a corresponding decoder. In other words, the feature f1 is output to a first decoder 111. The feature f2 is output to a second decoder 112. The feature f3 is output to a third decoder 113. The feature amount f4 is output to a fourth decoder 114. The feature amount f5 is output to a fifth decoder 115.

Next, a feature map for class estimation is estimated for each pixel using a convolutional neural network of each decoder.

Next, the five feature maps for the class estimation with different resolutions estimated by each decoder are aggregated by a feature aggregation (Feature Aggregation) section 116. Aggregation is done by summing the pixels or by connecting concatenating the five feature maps for the class estimation in a channel direction.

Next, a class predictor (Class predictor) section 117 calculates the probability of each class 1 to N for each pixel by the convolution operation so that the number of channels in the feature map aggregated by the feature aggregation section 116 is N. The class ID corresponding to the highest probability among N predicted values is the semantic segmentation result (estimation result).

Thus, the class IDs of all pixels in the input image 9 are estimated and the semantic segmentation result 11 is obtained.

### [Object Detection (Instance Segmentation)]

FIG. 8 is a schematic diagram showing a neural network of the object detection 102 (instance segmentation). The second task a estimation section 361 uses the neural network of the object detection 102 to perform the instance segmentation.

In the instance segmentation, a mask is detected for each object in the input image 9 and the type (class) of the area is also estimated. In the instance segmentation, the mask for each object can be detected, even if the plurality of objects of the same class are adjacent to each other.

As shown in FIG. 8, each of the features f1 to f5 of the input image 9 output from the feature extractor 37 is output to the corresponding decoder. That is, the feature f1 is output to the first object decoder 121. The feature f2 is output to the second object decoder 122. The feature f3 is output to the third object decoder 123. The feature f4 is output to the fourth object decoder 124. The feature f5 is output to the fifth object decoder 125.

Next, using the convolutional neural network of each decoder, a bounding box and a bounding box class for each object are estimated.

Next, from a location of the bounding box estimated by each decoder, the features in a bounding box area are cut out from the features corresponding to the bounding box (any of f1 to f5), and the cut features are output to the mask estimation (Mask Predictor) section 127.

Next, the class for each object area is estimated from the features of the bounding box area by the mask estimation section 127.

As described above, the object detection result 12 to which the image recognition processing is done is obtained from the input image 9.

### [Motion Detection (Optical Flow)]

FIG. 9 is a schematic diagram showing a neural network of the motion detection 103 (optical flow). The second task b estimation section 362 uses the neural network of the motion detection 103 to perform an optical flow estimation.

As shown in FIG. 9, in the optical flow, a moving amount for each pixel between the two input images 9a and 9b is calculated. The two input images 9a and 9b are images acquired at the same sensor section 2 and are, for example, the image of the current frame and the image one frame before.

As shown in FIG. 9, the features f1 to f5 are extracted from the two input images 9a and 9b, respectively, by the feature extractor 37.

Next, the feature f5 extracted from the input image 9a and the feature f5 extracted from the input image 9b are matched by a feature matching section 136. In the feature matching section 136, the features extracted from the different images are matched to each other. A matching result is input to the fifth optical flow decoder (optical flow decoder) 135. The fifth optical flow decoder 135 calculates the optical flow with the same resolution as the feature f5.

Next, the feature f4 extracted from the input image 9a and the feature f4 extracted from the input image 9b are matched by the feature matching section 136. The matching result is output to the fourth optical flow decoder 134. Furthermore, after being calculated by the fifth optical flow decoder 135, the optical flow that is up-sampled and expanded by an up-sampling section 137 is output to the fourth optical flow decoder 134. Then, the optical flow with the same resolution as the feature f4 is calculated by the fourth optical flow decoder 134. Here, when the optical flow is calculated by the fourth optical flow decoder 134, after being calculated by the fifth optical flow decoder 135, the optical flow expanded is also used, so that the optical flow can be calculated more accurately.

Next, the feature f3 extracted from the input image 9a and the feature f3 extracted from the input image 9b are matched by the feature matching section 136. The matching result is output to the third optical flow decoder 133. Furthermore, after being calculated by the fourth optical flow decoder 134, the optical flow is up-sampled and expanded by the up-sampling section 137, and is output to the third optical flow decoder 133. The third optical flow decoder 133 then calculates the optical flow with the same resolution as the feature f3. In the same way as described above, when the optical flow is calculated by the third optical flow decoder 133, after being calculated by fourth optical flow decoder 134, the optical flow expanded is also used, so that the optical flow can be calculated more accurately.

Next, the feature f2 extracted from the input image 9a and the feature f2 extracted from the input image 9b are matched by the feature matching section 136. The matching result is output to the second optical flow decoder 132. Furthermore, after being calculated by the third optical flow decoder 133, the optical flow is up-sampled and expanded by the up-sampling section 137, and is output to the second optical flow decoder 132. The optical flow with the same resolution as the feature f2 is then calculated by the second optical flow decoder 132. In the same way as described above, when the optical flow is calculated by the second optical flow decoder 132, after being calculated by the third optical flow decoder 133, the optical flow expanded is also used, so that the optical flow can be calculated more accurately.

Next, the feature f1 extracted from the input image 9aand the feature f1 extracted from the input image 9b are matched by the feature matching section 136. The matching result is output to the first optical flow decoder 131. Furthermore, after being calculated by the second optical flow decoder 132, the optical flow is up-sampled and expanded by the up-sampling section 137, and is output to the first optical flow decoder 131. The optical flow with the same resolution as the feature f1 is then calculated by the first optical flow decoder 131. In the same way as described above, when the optical flow is calculated by the first optical flow decoder 131, after being calculated by the second optical flow decoder 132, the optical flow expanded is also used, so that the optical flow can be calculated more accurately. In this way, the optical flow is calculated in combination with the output of the optical flow decoder calculated in the previous stage, thus obtaining a highly accurate optical flow result (motion detection result).

As described above, the optical flow result 13 is obtained from the input images 9a and 9b.

### [Distance Detection]

FIG. 10 is a schematic diagram showing a neural network of the distance detection 104. The second task c estimation section 363 uses the neural network of the distance detection 104 (second task) to perform a distance estimation. In the distance estimation, depth (depth) information (distance information between object and vehicle) is estimated for each pixel from the input image 9.

As shown in FIG. 10, in the neural network of the distance detection 104, after aggregating the plurality of features f1 to f5 each of different resolution extracted from the input image 9 and the features extracted from a LiDAR point cloud 15 acquired by the distance measuring section 21, a depth decoder, which is a decoder for the distance estimation, calculates a distance (distance between object and vehicle (in more detail, image capturing section)) for each pixel. Hereinafter, it will be described in detail.

As shown in FIG. 10, the features f1 to f5 are extracted from the input image 9 acquired by the image capturing section 20 of the sensor section 2 by the feature extractor 37. In addition, RestNet (He, Kaiming, et al., “Deep residual learning for image recognition.” Proceedings of IEEE conference on computer vision and pattern recognition. 2016.) 16 is used for the LiDAR point cloud 15 acquired by the distance measuring section 21 of the same sensor section 2 to extract a LiDAR feature map (hereinafter referred to as LiDAR features).

Next, the feature f5 extracted from the input image 9 and a LiDAR feature extracted from the LiDAR point cloud 15 are aggregated by a feature aggregation section ((Feature Aggregation) section 146. Aggregation is done by summing for each pixel. Alternatively, the features for each pixel may be concatenated in the channel direction. An aggregation result (aggregated feature) is output to a fifth depth decoder (depth decoder) 145. The fifth depth decoder 145 calculates the distance detection result with the same resolution as the feature f5.

Next, the feature f4 extracted from the input image 9 and the LiDAR feature extracted from the LiDAR point cloud 15 are aggregated by the feature aggregation section 146. The aggregation result is output to the fourth depth decoder 144. Furthermore, after being calculated by the fifth depth decoder 145, the distance detection result is up-sampled and expanded by the up-sampling section 147, and is output to the fourth depth decoder 144. The fourth depth decoder 144 then calculates the distance detection result with the same resolution as the feature f4. Here, when the distance is calculated by the fourth depth decoder 144, after being calculated by the fifth optical flow decoder 145, the distance detection result expanded is also used, so that the distance detection result can be calculated more accurately.

Next, the feature f3 extracted from the input image 9 and the LiDAR feature extracted from the LiDAR point cloud 15 are aggregated by the feature aggregation section 146. The aggregation result is output to the third depth decoder 143. Furthermore, after being calculated by the fourth depth decoder 144, the distance detection result, which is up-sampled and expanded by the up-sampling section 147, is output to the third depth decoder 143. The third depth decoder 143 then calculates the distance detection result with the same resolution as the feature f3. Here, when the distance is calculated by third depth decoder 143, after being calculated by the fourth optical flow decoder 144, the distance detection result expanded is also used, so that the distance detection result can be calculated more accurately.

Next, the feature f2 extracted from the input image 9 and the LiDAR feature extracted from the LiDAR point cloud 15 are aggregated by the feature aggregation section 146. The aggregation result is output to the second depth decoder 142. Furthermore, after being calculated by the third depth decoder 143, the distance detection result is output to the second depth decoder 142, which is up-sampled and expanded by the up-sampling section 147. The second depth decoder 142 then calculates the distance detection result with the same resolution as the feature f2. Here, when the distance is calculated by the second depth decoder 142, after being calculated by the third optical flow decoder 143, the distance detection result expanded is also used, so that the distance detection result can be calculated more accurately.

Next, the feature f1 extracted from the input image 9 and the LiDAR feature extracted from the LiDAR point cloud 15 are aggregated by the feature aggregation section 146. The aggregation result is output to the first depth decoder 141. Furthermore, after being calculated by the second depth decoder 142, the distance detection result is up-sampled and expanded by the up-sampling section 147, and is output to the first depth decoder 141. The first depth decoder 141 then calculates the distance detection result 14 with the same resolution as the feature f1. Here, when the distance is calculated by the first depth decoder 141, after being calculated by the second optical flow decoder 142, the distance detection result expanded is also used, so that the distance detection result can be calculated more accurately. In this way, the distance detection result is calculated in combination with the output of the depth decoder calculated in the previous stage, thus obtaining a highly accurate distance detection result.

As described above, the distance detection result 14 is obtained from the image 9.

As described above, the four tasks (semantic segmentation, object detection, motion detection, and distance detection) can be performed in the processing section 3 of the information processing apparatus 10a using a common feature extractor 37.

### [Information Processing Method (Image Recognition Processing Method)]

The information processing method (image recognition processing method) in the information processing apparatus 10a is described with reference to FIG. 11. The information processing shown in FIG. 11 is performed for each of the images acquired by each sensor section 2.

The image 9 captured by the image capturing section 20 of the sensor section 2 is acquired by the image acquisition section 30 (S1).

Next, the plurality of features of the image 9 (f1 to f5) is extracted by the feature extraction section 31 (S2).

Next, the first task (semantic segmentation) is performed by the first task estimation section 32 using the plurality of features extracted in S2 (S3).

Next, the second task decision section 33 decides whether or not to perform the second task based on the result of the first task (S4). In this embodiment, the second task decision section 33 decides whether or not to perform the object detection, the motion detection, and the distance detection, respectively.

Next, the parameter of the second task decided to be performed is generated by the parameter generation section 34 using the semantic segmentation result (S5).

Next, the neural network of the second task is configured by the second task neural network configuration section 35 using the parameter generated in S5 (S6).

Next, the second task (in this embodiment, one or more tasks selected from object detection, motion detection, and distance detection) is performed by the second task estimation section 36, using the neural network configured in S6 (S7).

### [Decision of Second Task]

FIG. 12 is a flow diagram of second task decision processing in Step 4 (S4) of FIG. 11, which is performed by the second task decision section 33 of the processing section 3. Hereinafter, it will be described how the second task to be performed is decided with reference to FIG. 12. The second task decision processing is based on the first task processing result (semantic segmentation result).

As shown in FIG. 12, when the second task decision processing is started, a unique class ID list (hereinafter simply referred to as ID list) is acquired from the semantic segmentation result that contains class ID information for each pixel (S1).

Next, using the ID list, it is determined whether or not there is the class ID of the object of interest (S42). When it is determined that there is the object of interest, it proceeds to S43. When it is determined that there is no object of interest, it is decided to perform the distance detection only (S44).

Here, as an example, the class IDs assigned in advance to each of the utility pole, the traffic signal, the traffic sign, the trash can, the pole, the vehicle (four-wheeled vehicle), the human, the animal, the bicycle, the motorcycle (two-wheeled vehicle), the train, the bus, and the truck are 1 to 13. These objects are the objects of interest (objects that are obstacles to driving). Of these, the vehicle with the class ID 6, the human with the class ID 7, the animal with the class ID 8, the bicycle with the class ID 9, the motorcycle with the class ID 10, the train with the class ID 11, the bus with the class ID 12, and the truck with the class ID 13 are the movable objects of interest. On the other hand, the utility pole with the class ID 1, the traffic signal with the class ID 2, the traffic sign with the class ID 3, the trash can with the class ID 4, and the pole with the class ID 5 are the non-movable objects of interest.

For example, in S42, if there are 1 to 13 class IDs in the ID list, it proceeds to S43. On the other hand, if there are no 1 to 13 class IDs in the ID list, it proceeds to S44, and it is decided to perform only the distance detection task.

In S43, it is determined whether or not there is the class ID of the movable object of interest in the ID list.

When it is determined that there is, the three tasks of the object detection, the motion detection, and the distance detection is decided to be performed (S46).

On the other hand, when it is determined that there is none, the two tasks of the object detection and the distance detection are decided to be performed (S45).

For example, in the example above, if there are 5 to 13 class IDs in the ID list, it proceeds to S46 and the three tasks of the object detection, the motion detection, and the distance detection are decided to be performed.

On the other hand, if there are no 5 to 13 class IDs in the ID list, it proceeds to S45 and the two tasks of the object detection and the distance detection are decided to be performed.

Thus, in this embodiment, based on the processing result of the first task (semantic segmentation result), it is decided whether or not to perform the second tasks of the object detection, the motion detection, and the distance detection, respectively.

Next, a specific example of the second task decision processing is described with respect to FIG. 13.

FIG. 13 is a diagram describing a specific example of the second task decision processing. FIG. 13 is a diagram describing how the second task to be performed is decided corresponding to the first task processing result on the image 9 acquired by the image capturing sections 20 of each of the plurality of sensor sections 2 mounted on the vehicle. In the second task decision processing, the scene feature obtained from the semantic segmentation is used to decide the second task to be performed.

In the example shown in FIG. 13, an image 9SL, which is acquired by the image capturing section 20 of the left side sensor section 2SL, and an image 9FL, which is acquired by the image capturing section 20 of the left front sensor section 2FL, are both images in which there are no object of interest.

Therefore, since the ID list obtained from semantic segmentation results 11SL and 11FL, which are the first task estimation results for the images 9SL and 9FL, respectively, does not contain the class ID of the object of interest, it is decided to perform only the distance detection.

Thus, if there is no object of interest, only the distance detection can be performed to estimate a distance between the road surface and the vehicle (vehicle on which image capturing section is mounted), for example. Using this estimated distance information of the objects that are not obstacles, it is possible to present the driving support information to the driver, such as the driving operation order, the speed change, the vehicle overtaking recommendation, the lane change recommendation, etc.

In the example shown in FIG. 13, an image 9F, which is acquired by the image capturing section 20 of the front sensor section 2F, and an image 9FR, which is acquired by the image capturing section 20 of the right front sensor section 2FR, are both images in which there are the vehicle, i.e., the movable object of interest.

Therefore, since the ID list obtained from the semantic segmentation results 11F and 11FR, which are the first task estimation results for the images 9F and 9FR, respectively, contains the class ID of the movable object of interest, it is decided to perform the tasks of the object detection, the motion detection, and the distance detection.

Thus, if there is the movable object of interest, the object detection, the motion detection, and the distance detection can be performed to estimate the motion and the distance (distance between object and vehicle) of each object. Using this estimated motion and distance information of each object, that is, the image recognition processing result, it is possible to present the driving support information to the driver, such as the obstacle warning, the driving operation order, the speed change, the vehicle overtaking recommendation, the lane change recommendation, etc.

In the example shown in FIG. 13, the image 9SR acquired by the image capturing section 20 of the right side sensor section 2SR is an image in which there is a fire hydrant, i.e., the non-movable object of interest.

Therefore, since the ID list obtained from a semantic segmentation result 11SR, which is the first task estimation result for the image 9SR, contains the class ID of the non-movable object of interest, it is decided to perform the object detection and the distance detection.

Thus, if there are non-movable stationary objects of interest, such as the fire hydrant, a wall, the curb, the poles, etc., the object detection and the distance detection can be performed to estimate the distance between these objects and the vehicle. Using this estimated distance information, i.e., the image recognition processing result, it is possible to present the driving support information to the driver, such as the obstacle warning, the driving operation order to avoid a collision with an obstacle, etc.

In the all-surrounding-area sensing system, in which the plurality of image capturing sections is mounted on the vehicle to acquire the vehicle surrounding information over a wide area, if four tasks are always performed for, for example, one image, the calculation amount becomes enormous, which easily causes the processing delay, and the real-time image recognition processing and the driving assistance based on the image recognition result become difficult.

In contrast, in this embodiment, by applying the image processing method (information processing method) of the present technology to each of the images acquired by each image capturing section, it is possible to reduce the calculation amount and the processing delay in the image recognition processing, as in the images acquired by the front sensor section and right front sensor section shown in FIG. 13, only if there is the movable object that is an obstacle, all the three second tasks are performed, and in other cases, two or one second task is only performed.

### [Second Task Parameter Generation]

FIG. 14 is a flow diagram of the second task parameter generation processing in Step 5 (S5) of FIG. 11, which is performed by the parameter generation section 34 of processing section 3.

FIG. 15 is a diagram describing a specific example of the parameter generation.

Hereinafter, along with FIG. 14, with reference to FIG. 15, it will be described how the parameter is generated for use in performing the second task. The parameter generation processing is performed using the first task processing result (semantic segmentation result).

As shown in FIG. 14, when the parameter generation processing is started, from the semantic segmentation result, it is determined whether or not there is the object of interest in the image (S51). In detail, it is determined whether or not there is the object of interest by determining whether or not there is the class ID of the object of interest using the ID list obtained from the semantic segmentation result.

When it is determined that there is no object of interest at S51, it proceeds to S53.

When it is determined that there is the object of interest at S51, it proceeds to S52.

In S53, the parameter is generated so that all areas of the input image 9 are processed for recognition using all features f1 to f5. The parameter generated is stored in the storage section 7 (S58).

As described in the second task decision processing above, if it is determined that there is no object of interest, it is decided to perform only the distance detection. In other words, if there is no object of interest, it is decided to perform only the distance detection, no optimization is performed for the neural network of the distance detection, and the distance detection is performed using all features f1 to f5 for entire areas of the input image 9. In other words, the distance detection is performed using the standard neural network.

In S52, the category of the object of interest is acquired. In detail, the category can be acquired by checking the class ID of the object of interest using the ID list. There may be the plurality of objects in a category acquisition result. The category acquisition result is the class ID list of the object of interest.

Next, it proceeds to S54 and S56.

In S54, the image area in which there is the object of interest is acquired. The image area to be acquired includes each area of the plurality of objects. A rectangular frame (also called bounding box) surrounding the object of interest is provided. The area of the frame when a size of the frame is the smallest (also called smallest area) is called a final image area. The final image area is called the “image to be processed”. The image to be processed is the area to be processed on which the second task processing is performed.

Next, a parameter of a coordinate of the image to be processed is generated (S55). The parameter generated is stored in the storage section 7 (S58).

The coordinate of the image to be processed is expressed in the form of parameter (x1, y1, w, h). The parameter (x1, y1, w, h) is expressed using a coordinate (x1, y1) of an upper left corner of the rectangular frame (bounding box) and (w, h) which indicates the number of horizontal and vertical pixels of the rectangle.

In S56, the number of pixels for each object of interest acquired in S52 is calculated, and a list of a minimum number of pixels is generated to include the minimum number of pixels for each category of the object of interest.

Next, using the list of the minimum number of pixels of the object of interest, a parameter representing the features to be used for the second task is generated (S57). The parameter generated is stored in the storage section 7 (S58).

The parameter generation generates the parameter of the features according to a table shown in FIG. 15, for example.

In the example shown in FIG. 15, if the object category is the four-wheeled vehicle, the parameter is generated such that when the number of pixels is T0 or less, the features to be used are f1, f2, and f3, when the number of pixels is greater than TO and less than T1, the features to be used are f2, g3, and f4, and when the number of pixels is greater than T1 and less than T2, the features to be used are f3, f4, and f5.

If the object category is the pedestrian, the parameter is generated such that when the number of pixels is T3 or less, the features to be used are f1, f2, and f3, when the number of pixels is greater than T3 and less than T4, the features to be used are f2, g3, and f4, and when the number of pixels is greater than T4 and less than T5, the features to be used are f4 and f5.

If the category of the object of interest is the cyclist, the parameter is generated such that when the number of pixels is T6 or less, the features to be used are f1, f2 and f3, when the number of pixels is greater than T6 and less than T7, the features to be used are f2, g3 and f4, and when the number of pixels is greater than T7 and less than T8, the features to be used are f4 and f5.

Next, a specific example of the parameter generation is described with reference to FIG. 16.

FIG. 16(A) is a diagram showing the image acquired by the image capturing section of each of the plurality of sensor sections 2 mounted on the vehicle 1, the semantic segmentation result, the object detection result, the motion detection result, and the distance detection result for the image 9. In FIG. 2, the object detection result, the motion detection result, and the distance detection result are the recognition processing results of using a neural network reconfigured and optimized with the parameter generated based on the semantic segmentation result, or the standard neural network.

FIG. 16(B) is a diagram showing an example of deciding the second task to be performed and generating the parameter based on the semantic segmentation result shown in FIG. 16(A).

In the example shown in FIG. 16(A), the image 9SL acquired by the image capturing section 20 of the left side sensor section 2SL is the image in which there is the movable object of interest.

Therefore, as shown in FIG. 16(B), since the ID list acquired from the semantic segmentation result for the image 9SL contains the class ID of the movable object of interest, it is decided to perform all the second tasks of the object detection, the motion detection, and the distance detection. As a parameter of the image to be processed, a parameter [xa, ya, wa, ha] is generated to indicate a coordinate of an area A surrounded by a rectangular frame that surrounds the object of interest in the Figure, and a parameter is generated so that the features f1, f2, and f3 are used. The parameter generation of the features is generated according to the number of pixels of the object of interest according to FIG. 15, as described above, and the same applies below.

In the example shown in FIG. 16(A), the image 9FL acquired by the image capturing section 20 of the left front sensor section 2FL is an image in which there is no object of interest.

Therefore, as shown in FIG. 16(B), the ID list acquired from the semantic segmentation result for the image 9FL does not include the class ID of the object of interest, so it is decided to perform the distance detection only. In addition, the parameter is generated so that the entire image area is the target image to be processed and all features f1 to f5 are used. In FIG. 16(B), the coordinate of the image to be processed for the entire image area is expressed as a parameter [0, 0, w, h].

In the example shown in FIG. 16(A), the image 9F, which is acquired by the image capturing section 20 of the front sensor section 2F, is an image in which there is the movable object of interest.

Therefore, as shown in FIG. 16(B), the ID list acquired from the semantic segmentation result for the image 9F contains the class ID of the movable object of interest, so the execution of all the second tasks of the object detection, the motion detection, and the distance detection is decided. As the parameter of the image to be processed, a parameter [xb, yb, wb, hb] indicating a coordinate of an area B, which is surrounded by a rectangular frame surrounding the object of interest in the Figure, and a parameter [xc, yc, wc, hc] indicating a coordinates of an area C are generated. A parameter is generated so that the features f1, f2, and f3 are used for the area B, and a parameter is generated so that the features f3, f4, and f5 are used for the area C.

In the example shown in FIG. 16(A), the image 9FR acquired by the image capturing section 20 of the right front sensor section 2FR is an image in which there is the movable object of interest.

Therefore, as shown in FIG. 16(B), the ID list acquired from the semantic segmentation result for the image 9FR contains the class ID of the movable object of interest, so all the second tasks of the object detection, the motion detection, and the distance detection is decided to be performed. As the parameter of the image to be processed, a parameter [xd, yd, wd, hd] is generated to indicate a coordinate of an area D surrounded by a rectangular frame surrounding the object of interest in the Figure, and a parameter is generated so that the features f1, f2, and f3 are used.

In the example shown in FIG. 16(A), the image 9SR acquired by the image capturing section 20 of the right side sensor section 2SR is an image in which there is the movable object of interest.

Therefore, as shown in FIG. 16(B), the ID list acquired from the semantic segmentation result for the image 9SR contains the class ID of the movable object of interest, so all the second tasks of the object detection, the motion detection, and the distance detection is decided to be performed. As the parameter of the image to be processed, a parameter [xe, ye, we, he] indicating a coordinate of an area E, which is surrounded by a rectangular frame surrounding the object of interest in the Figure, and a parameter [xf, yf, wf, hf] indicating the coordinates of area F are generated. A parameter is generated so that the features f1, f2, and f3 are used for an area E, and a parameter is generated so that the features f3, f4, and f5 are used for an area F.

### [Neural Network Configuration for Second Task]

FIG. 17 shows a diagram showing an example of a neural network configuration example performed in the second task neural network configuration section 35 of processing section 3.

FIG. 17 shows the neural network configuration example using the second task and the parameter decided to be performed, shown in FIG. 16(B), in the recognition task for each input image shown in FIG. 16(A).

By reconfiguring the neural network of the second task using the parameter generated, estimation processing for the second task, which is decided to be performed in S33, can be performed with a smaller calculation amount, depending on a size of the object of interest in the input image, and the estimation processing can be more optimal. In the neural network configuration, the configuration changes to select the decoder for each second task using the parameter generated.

Hereinafter, a specific example will be described using FIG. 17.

For the image 9SL acquired by the left lateral sensor section 2SL, the second task decision processing decides all three recognition tasks (second tasks): the object detection, motion detection processing, and the distance detection to be performed, as described above.

In performing these three second tasks, the image to be processed is only the area A [xa, ya, wa, ha], as shown in FIG. 17. In addition, since there are only small objects located in a distance in the area A, only high resolution features f1, f2, and f3 are configured to be generated, and furthermore, in accordance with this, the neural network of each second task is reconfigured so that the decoders used in the processing of the second task are configured only of those corresponding to f1, f2, and f3. In more detail, in the object detection, it is reconfigured so that only the first, second and third object decoders 121 to 123 are used. In the motion detection, it is reconfigured to use only the first, second and third optical flow decoders 131 to 133. In the distance detection, it is reconfigured to use only the first, second, and third depth decoders 141 to 143.

For the image 9FL acquired by the left front sensor section 2FL, as described above, the second task decision processing decides that only the distance detection is to be performed. In performing the distance detection, as shown in FIG. 17, the image to be processed is the entire area, and the neural network of the distance detection is configured so that the features f1 to f5 are generated, and furthermore, the neural network of the distance detection is configured so that the decoder used in the distance detection is configured of those corresponding to f1 to f5. In more detail, it is configured so that the first to fifth depth decoders 141 to 145 are used. In other words, no optimization will be performed and the distance detection will be performed using the standard neural network.

For the image OF acquired by the front sensor section 2F, the second task decision processing decides to perform all the three recognition tasks (second tasks) of the object detection, the motion detection processing, and the distance detection, as described above.

In performing these three second tasks, the images to be processed are only the area B [xb, yb, wb, hb] and the area C [xc, yc, wc, hc], as shown in FIG. 17.

In the area B, since there are only small objects located in the distance in the area B, it is configured such that only the high resolution features f1, f2, and f3 are generated, and furthermore, in accordance with this, the neural network of each second task is reconfigured so that the decoders used in the second task are configured only of those corresponding to f1, f2, and f3.

On the other hand, in the area C, since there are large objects located near the area C, it is configured such that only the features f2, f3, and f4 with low resolution but with a wide range of edge information are generated, and furthermore, in accordance with this, the neural network of each second task is reconfigured so that the decoders used in the second task are configured only of those corresponding to f2, f3, and f4.

In detail, the object detection is reconfigured to use only the first, second, and third object decoders 121 to 123 in the area B and only the second, third, and fourth object decoders 122 to 124 in the area C. The motion detection is reconfigured to use only the first, second, and third optical flow decoders 131 to 133 in the area B and only the second, third, and fourth optical flow decoders 132 to 134 in the area C. The distance detection is reconfigured to use only the first, second, and third depth decoders 141 to 143 in the area B and only the second, third, and fourth depth decoders 142 to 144 in the area C.

For the image 9SL acquired by the left lateral sensor section 2SL, all three recognition tasks (second tasks): the object detection, the motion detection processing, and the distance detection are decided to be performed by the second task decision processing, as described above.

In performing these three second tasks, the image to be processed is only the area D [xd, yd, wd, hd], as shown in FIG. 17. In addition, since there are only small objects located in the distance in the area D, it is configured such that only the high resolution features f1, f2, and f3 are generated, and furthermore, in accordance with this, the neural network of each second task is reconfigured so that the decoders used in the second task are configured only of those corresponding to f1, f2, and f3. In more detail, in the object detection, it is reconfigured so that only the first, second and third object decoders 121 to 123 are used. In the motion detection, it is reconfigured to use only the first, second and third optical flow decoders 131 to 133. In the distance detection, it is reconfigured to use only the first, second, and third depth decoders 141 to 143.

For the image 9SR acquired by the right side sensor section 2SR, all three recognition tasks (second tasks): the object detection, the motion detection processing, and the distance detection are decided to be performed by the second task decision processing, as described above.

In performing these three second tasks, the images to be processed are only the area E [xe, ye, we, he] and the area F [xf, yf, wf, hf].

In the area E, since there are only small objects located in the distance in the area E, it is configured such that only the high resolution features f1, f2, and f3 are generated, and furthermore, in accordance with this, the neural network of each second task is reconfigured so that the decoders used in the second task are configured only of those corresponding to f1, f2, and f3.

On the other hand, in the area F, since there are large objects located near the area F, it is configured such that only the features f2, f3, and f4 with low resolution but with a wide range of edge information are generated, and furthermore, in accordance with this, the neural network of each second task is reconfigured so that the decoders used in the second task are configured only of those corresponding to f2, f3, and f4.

In detail, the object detection is reconfigured to use only the first, second, and third object decoders 121 to 123 in the area E and only the second, third, and fourth object decoders 122 to 124 in the area F. The motion detection is reconfigured to use only the first, second, and third optical flow decoders 131 to 133 in the area E and only the second, third, and fourth optical flow decoders 132 to 134 in the area F. The distance detection is reconfigured to use only the first, second, and third depth decoders 141 to 143 in the area E and only the second, third, and fourth depth decoders 142 to 144 in the area F.

As described above, the present technology can reduce the calculation amount by extracting the five features f1 to f5 that can be commonly used in the plurality of tasks. In addition, since it is possible to decide the second task to be performed and generate the parameter according to the processing result of the first task, the neural network of the second task can be optimized. This makes it possible to reduce the calculation amount on a decoder side, for example, compared to processing with the standard neural network.

With reference to FIG. 18, the calculation amount on the decoder side can be reduced by taking the distance detection as an example.

Here is an example of the distance detection performed for the image 9SL, in which the movable object of interest is present, acquired by the left side sensor section 2SL shown in FIG. 16.

FIG. 18(A) is a diagram showing the standard neural network 104, which is similar to that shown in FIG. 10 above.

FIG. 18(B) is a diagram showing a neural network 104a that is reconstructed using the features f1, f2, and f3 that are decided that only the distance detection is performed based on the semantic segmentation result, and is generated as the parameter.

As shown in FIGS. 18(A) and 18(B), the reconstructed neural network 104a of the distance detection uses fewer decoders than the standard neural network. This optimizes the distance detection processing (second task processing) and reduces the calculation amount on the decoder side.

Also, in the object detection and the motion detection, the neural network can be reconstructed in the same way, and the calculation amount on the decoder side can be reduced by reducing the number of decoders used compared to the standard neural network.

If there is no object of interest, the task processing is performed using the standard neural network.

As described above, in the present technology, only the necessary recognition task (second task) is processed according to the scene features based on the semantic segmentation result. Furthermore, the parameter is generated using the semantic segmentation result, and the neural network of the second task is optimized using the parameter. This allows the calculation amount of the image recognition processing to be reduced while achieving the highly accurate image recognition processing, thereby reducing the power consumption and the processing delay. As a result, appropriate and real-time presentation of the driving support information based on highly accurate image recognition processing result becomes possible while reducing the calculation amount of a vehicle surroundings sensing system.

### Third Embodiment

In the third embodiment, the technology described in the first embodiment is applied to the image recognition processing of each image acquired by each of the plurality of image capturing sections mounted on the vehicle, and the image recognition processing result is used for the automatic driving. The second and third embodiments differ mainly in a destination to which the image recognition processing result is applied, and the other configurations are almost the same. Hereinafter, different points are mainly described.

### [Information Processing Systems]

FIG. 19 is a schematic diagram of an information processing system 200 according to this embodiment. In the information processing system 200, automatic driving processing is performed using the image recognition processing results of the plurality of image capturing sections mounted on the vehicle 1. The information processing system of this embodiment can be rephrased as an automatic driving system.

As shown in FIG. 19, the information processing system 200 has the plurality of sensor sections 2, the information processing apparatus 10b, the vehicle status detection section 5, and a drive system 26. All of these are mounted on the vehicle 1.

### (Sensor Section)

Each sensor section 2 includes the image capturing section 20 and the distance measuring section 21.

The image capturing section 20 acquires the image. The monocular camera, the stereo camera, or the like can be used for the image capturing section 20.

The distance measuring section 21 is configured to be capable of measuring the distance between the vehicle 1 and the object around the vehicle 1. As the distance measuring section 21, the LiDAR, the stereo camera, the millimeter wave radar, etc. can be used, and the distance measuring section 21 is configured to include one or more selected from these. In this embodiment, an example is given in which the LiDAR is used as the distance measuring section 21.

The image acquired by the image capturing section 20 of the sensor section 2 and 3D point cloud information acquired by the LiDAR as the distance measuring section 21 are output to the information processing apparatus 10b.

### (Vehicle Condition Detection Section)

The vehicle status detection section 5 detects the status of the vehicle. For example, the vehicle status detection section 5 includes the gyro sensor, the acceleration sensor, and the sensors for detecting the amount of operation of the accelerator pedal, the amount of operation of the brake pedal, the steering angle, the engine rotation speed, the motor rotation speed, or the vehicle rotation speed. The vehicle information detected by the vehicle status detection section 5, such as the speed and the steering angle of the vehicle 1, is output to the presentation control section 24 described below.

### (Drive System)

The drive system 26 includes various devices related to the drive system of the vehicle (own vehicle) 1. For example, the drive system includes a driving force generator such as an internal combustion engine or a driving motor, a driving force transmission mechanism for transmitting the driving force to wheels, a steering mechanism for adjusting the steering angle, a braking device for generating braking force, an ABS (Antilock Brake System), an ESC (Electronic Stability Control), and an electric power steering system.

The drive system 26 is controlled based on various control signals supplied from a drive system control section 25, described below.

### (Information Processing Apparatus)

The information processing apparatus 10b has the hardware configuration necessary for the computer, for example, the CPU and the memory (RAM, ROM). The CPU loads the program stored in the storage section 7 (described below) into the RAM and performs it to perform various processes, including the image recognition processing according to the present technology.

In the information processing apparatus 10b, the semantic segmentation (first task) is performed for each input image from the image capturing section 20 of each of the plurality of sensor sections 2. The semantic segmentation result is used to decide the task (second task) to be used for the image recognition processing, and the parameter of that task is generated.

The information processing apparatus 10b includes the processing section 3, the image acquisition section 30, the situation analysis section 8, the planning section 24, the drive system control section 25, and the storage section 27.

### ((Image Acquisition Section))

The image acquisition section 30 acquires the image acquired by the image capturing section 20 of each sensor section 2. The image is output to the processing section 3.

### ((Processing Section))

The processing section 3 performs the image recognition of the image (input image) acquired by the image acquisition section 30. At this time, as described in the first and second embodiments, the processing section 3 uses the result of performing the first task made for the input image to decide whether or not to perform the second task and to generate the parameter of the second task.

### ((Situation Analysis Section))

The situation analysis section 8 performs the analysis processing of the surrounding situation of the vehicle based on the recognition processing result of the first task (semantic segmentation result) and the recognition processing result of the second task (one or more processing results selected from object detection result, motion detection result, and distance detection result). The analysis result is output to the planning section 24.

### ((Planning Section))

The planning section 24 plans a route and an action of the vehicle 1 to safely travel the route to the destination in time. In the planning section 24, the route and the action are planned so that the own vehicle avoids a collision or mitigates an impact, follows the vehicle based on a distance between vehicles, maintains a vehicle speed, etc. when the vehicle is traveling in the automatic driving.

The planning section 24 has a route planning section 240 and an action planning section 241.

The route planning section 240 plans the route to the destination using the map information and the status information of the vehicle 1 detected by the vehicle status detection section 5. The route planning section 240 also changes the route as appropriate using the analysis result of the situation analysis section 8. The route planning section 240 outputs data indicating the planned route to the action planning section 241.

The action planning section 241 plans the action of the vehicle 1 to safely travel the route planned by the route planning section 240 within the planned time. For example, the action planning section 241 plans starting, stopping, direction of travel (e.g., forward, backward, left turn, right turn, change of direction, etc.), a travel lane, a travel speed, and overtaking. The action planning section 241 supplies data indicating the planned action of the vehicle 1 to the drive system control section 25. The action planning section 241 also changes the action plan as appropriate using the analysis result of the situation analysis section 8.

For example, if it is recognized that there is only non-movable object of interest in the input image, the object detection and the distance detection are performed in an input image recognition processing. Then, according to the distance information between the vehicle and the object of interest estimated by the distance detection, the steering angle and the brake can be automatically controlled to avoid the collision with the object of interest.

On the other hand, if it is recognized that there is the movable object of interest in the input image, the object detection, the motion detection, and the distance detection are performed in the input image recognition processing. Then, according to the motion information and the distance information of the object of interest estimated by each detection, the steering angle and braking can be automatically controlled to avoid the collision with the object of interest.

Thus, in the image recognition processing according to this embodiment, if there is only the non-movable object of interest, no motion detection is performed, thus enabling a reduction in the calculation amount in the image recognition processing without degrading the recognition accuracy. The image recognition result can then be used to realize automatic steering and automatic braking functions.

The analysis result of the surrounding situation of the vehicle by the situation analysis section 8 described above is generated using the image recognition processing result in the processing section 3. The processing section 3 of the information processing apparatus 10b in this embodiment can perform the image recognition processing without degrading image recognition accuracy. Therefore, the analysis result of the surrounding situation of the vehicle performed using the highly accurate image recognition processing result is highly accurate information. The route plan and the action plan made using this highly accurate information are more suitable for the situation in which the vehicle 1 is placed, and the safety of the automatic driving is further improved.

Moreover, the processing section 3 of the information processing apparatus 10b of the present technology can reduce the calculation amount in the image recognition processing, thereby suppressing the processing delay and enabling the automatic driving based on more precise route planning and action planning at the precise timing.

### ((Driveline Control Section))

The drive system control section 25 generates various control signals based on the data indicating the action of the vehicle 1 planned by the action planning section 241, and supplies them to the drive system 26.

### ((Storage Section))

The storage section 27 stores various programs and data necessary for processing in the information processing apparatus 10b. For example, the storage section 27 stores the program for performing a series of processes according to the image recognition processing performed in the processing section 3 of the present technology. For example, the storage section 27 stores various parameters used in the processing according to the image recognition processing and logs relating to the vehicle travel, etc. For example, the storage section 27 stores the program for performing a series of processes performed by the situation analysis section 8, the presentation control section 24, and the drive system control section 25.

The storage section 27 includes, for example, the magnetic storage device such as the ROM, the RAM, and the HDD, the semiconductor storage device, the optical storage device, and the magneto-optical storage device.

The series of the information processing method in the processing section 3 are the same as in the second embodiment.

In this embodiment, as in the first and second embodiments, the calculation amount can be reduced by extracting the five features f1 to f5 that can be commonly used in the plurality of tasks. In addition, since it is possible to decide the second task to be performed and generate the parameter according to the processing result of the first task, the neural network of the second task can be optimized. This makes it possible to reduce the calculation amount on the decoder side, for example, compared to the processing with the standard neural network.

This configuration makes it possible to reduce the calculation amount according to the image recognition processing while achieving highly accurate image recognition processing. This enables a reduction in the power consumption and the processing delay, and allows for precise, a real-time automatic driving (autonomous driving) control based on the image recognition processing result.

### <Others>

The above is a description of embodiments of the present invention. The present invention is not limited only to the embodiments described above, and of course, various changes can be made within the scope that does not depart from the gist of the invention.

In the above embodiments, the example using the LiDAR as the distance measuring section is given, but for example, the stereo camera may be used instead of the LiDAR, and the image recognition processing may be performed using the 3D point cloud obtained from a stereo image acquired with the stereo camera. In this configuration, the semantic segmentation (first task) result can be used to reduce the number of operations for stereo disparity estimation, and the calculation amount can be reduced.

Alternatively, a depth map may be predicted from the stereo image acquired by the stereo camera, and then each pixel may be projected to LiDAR coordinates to obtain a pseudo LiDAR point cloud that is converted from the depth map image to the point cloud.

In the embodiments described above, the example is given in which the image capturing section that acquires the image for the image recognition processing of the present technology is mounted on the moving object, but it is not limited to this. The moving object on which the image capturing section is mounted may be other vehicle such as a two-wheeled vehicle, a cleaning robot, a toy-type robot, a drone, and the like.

In the above embodiment, the example of the processing section 3 that performs the image recognition processing according to the present technology being mounted on the vehicle (moving object) is given, but it is not limited to this, and may be a server existing on an external network, for example. From the viewpoint of reducing the processing delay, it is preferable that the processing section be mounted on the moving object on which the image capturing section is mounted.

The present technology may also have the following structures.

(1)
An information processing apparatus, including:

a processing section capable of processing a plurality of tasks for a recognition target, including first and second tasks that share a feature extraction, in which

the processing section decides whether or not to perform the second task processing using a recognition result of the recognition target from the first task processing.

(2)
The information processing apparatus according to (1), in which

the processing section generates a parameter of the second task using the recognition result of the recognition target from the first task processing.

(3)
The information processing apparatus according to (2), in which

the processing section uses the parameter generated to configure a neural network of the second task.

(4)
The information processing apparatus according to (2) or (3), in which

the processing section extracts a plurality of features from the recognition target and decides whether or not to perform the second task processing and generates the parameter using the recognition result of the recognition target from the first task processing by using the plurality of features.

(5)
The information processing apparatus according to (4), in which

the parameter includes an area to be processed for the second task and one or more features selected from the plurality of features.

(6)
The information processing apparatus according to any one of (2) to (5), in which

the processing section decides whether or not to perform the second task processing and generates the parameter using a scene feature obtained from the recognition result of the recognition target from the first task processing.

(7)
The information processing apparatus according to (6), in which

the recognition target is an image acquired by an image capturing section mounted on a moving object that captures surroundings of the moving object, and

the scene feature is a moving scene feature of the moving object, which means whether or not there is an object of interest in the image and whether or not the object of interest is a movable object.

(8)
The information processing apparatus according to (7), in which

the object of interest is an object that is an obstacle to a movement of the moving object.

(9)
The information processing apparatus according to (7) or (8), in which

the first task is semantic segmentation,

the second task includes object detection and motion detection, and distance detection, and

the processing section only performs the distance detection if there is no object of interest in the image,
performs the object detection and the distance detection if there is the object of interest in the image and the object of interest is not the movable object, and
performs the object detection, the motion detection, and the distance detection if there is the object of interest in the image and the object of interest is the movable object.
   (10)
   The information processing apparatus according to (9), in which

the parameter includes the area to be processed for the second task and one or more features selected from the plurality of features, and

the processing section generates the parameter if there is no object of interest in the image such that an entire image area is taken as the area to be processed and all of the plurality of features are used, and
generates the parameter if there is the object of interest in the image such that the smallest area surrounding the object of interest is taken as the area to be processed and one or more features selected from the plurality of features are used according to the number of pixels in the object of interest.
   (11)
   The information processing apparatus according to (9) or (10), in which

a distance measuring section is mounted on the moving object, and

in the distance detection, a distance is estimated using an aggregated result of aggregating the features extracted from the image and distance features obtained by the distance measuring section.

(12)
The information processing apparatus according to (11), in which

the distance measuring section includes one or more selected from LiDAR (Light Detection and Ranging), a stereo camera, and a millimeter wave radar.

(13)
The information processing apparatus according to any one of (7) to (12), in which

the plurality of image capturing sections is mounted on the moving object, and

the processing section decides whether or not to perform the second task processing and generates the parameter using the image recognition result from the first task processing for each image acquired by each of the plurality of image capturing sections mounted on the moving object.

(14)
The information processing apparatus according to any one of (7) to (13), in which

the image capturing section is a stereo camera or a monocular camera.

(15)
The information processing apparatus according to any one of (7) to (14), in which

the processing section performs the second task on the image using the neural network of the second task configured by using the parameter generated, and

further includes a presentation control section that controls a presentation section that provides assistance to an operator of the moving object based on a recognition result of the second task.

(16)
The information processing apparatus according to (15), in which

one or more selected from a display section, a light emission section, and a sound output section as the presentation section is mounted on the moving object, and

the presentation control section controls at least one of display control of the display section, lighting control of the light emission section, and sound output control of the sound output section.

(17)
The information processing apparatus according to any one of (7) to (16), in which

the moving object is a moving object capable of moving autonomously, and

the processing section performs the second task on the image using the neural network of the second task configured by using the parameter generated, and

further includes a planning section that plans a travel and an action of the moving object based on the recognition result of the second task.

(18)
The information processing apparatus according to any one of (1) to (17), in which

the recognition target is an image,

the first task is the semantic segmentation, and

the second task includes one or more selected from the object detection, the motion detection, the distance detection, normal estimation, attitude estimation, and trajectory estimation.

(19)
An information processing method performed by an information processing apparatus, including

processing a first task for a recognition target, and

deciding whether or not to perform a second task that shares a feature extraction with the first task using a recognition result of the recognition target from the first task processing.

(20)
A program that causes an information processing apparatus to perform

a step of processing a first task for a recognition target, and

a step of deciding whether or not to perform a second task that shares a feature extraction with the first task using a recognition result of the recognition target from the first task processing.

### REFERENCE SIGNS LIST

1 vehicle (moving object)
3 processing section
4 presentation control section
40 display control section
41 sound control section
42 light emission control section
6 presentation section
60 display section
61 sound output section
62 light emission section
9 image, input image (recognition target)
10, 10a, 10b information processing apparatus
20 camera (image capturing section)
21 LiDAR (distance measuring section)
24 planning section
102 neural network of object detection (neural network or second task)
103 neural network of motion detection (neural network or second task)
104, 104a neural network of distance detection (neural network or second task)

1. An information processing apparatus, comprising:
a processing section capable of processing a plurality of tasks for a recognition target, including first and second tasks that share a feature extraction, wherein
the processing section decides whether or not to perform the second task processing using a recognition result of the recognition target from the first task processing.

2. The information processing apparatus according to claim 1, wherein
the processing section generates a parameter of the second task using the recognition result of the recognition target from the first task processing.

3. The information processing apparatus according to claim 2, wherein
the processing section uses the parameter generated to configure a neural network of the second task.

4. The information processing apparatus according to claim 2, wherein
the processing section extracts a plurality of features from the recognition target and decides whether or not to perform the second task processing and generates the parameter using the recognition result of the recognition target from the first task processing by using the plurality of features.

5. The information processing apparatus according to claim 4, wherein
the parameter includes an area to be processed for the second task and one or more features selected from the plurality of features.

6. The information processing apparatus according to claim 2, wherein
the processing section decides whether or not to perform the second task processing and generates the parameter using a scene feature obtained from the recognition result of the recognition target from the first task processing.

7. The information processing apparatus according to claim 6, wherein
the recognition target is an image acquired by an image capturing section mounted on a moving object that captures surroundings of the moving object, and
the scene feature is a moving scene feature of the moving object, which means whether or not there is an object of interest in the image and whether or not the object of interest is a movable object.

8. The information processing apparatus according to claim 7, wherein
the object of interest is an object that is an obstacle to a movement of the moving object.

9. The information processing apparatus according to claim 7, wherein
the first task is semantic segmentation,
the second task includes object detection and motion detection, and distance detection, and
the processing section only performs the distance detection if there is no object of interest in the image,
performs the object detection and the distance detection if there is the object of interest in the image and the object of interest is not the movable object, and
performs the object detection, the motion detection, and the distance detection if there is the object of interest in the image and the object of interest is the movable object.

10. The information processing apparatus according to claim 9, wherein
the parameter includes the area to be processed for the second task and one or more features selected from the plurality of features, and
the processing section generates the parameter if there is no object of interest in the image such that an entire image area is taken as the area to be processed and all of the plurality of features are used, and
generates the parameter if there is the object of interest in the image such that the smallest area surrounding the object of interest is taken as the area to be processed and one or more features selected from the plurality of features are used according to the number of pixels in the object of interest.

11. The information processing apparatus according to claim 9, wherein
a distance measuring section is mounted on the moving object, and
in the distance detection, a distance is estimated using an aggregated result of aggregating the features extracted from the image and distance features obtained by the distance measuring section.

12. The information processing apparatus according to claim 11, wherein
the distance measuring section includes one or more selected from LiDAR (Light Detection and Ranging), a stereo camera, and a millimeter wave radar.

13. The information processing apparatus according to claim 7, wherein
the plurality of image capturing sections is mounted on the moving object, and
the processing section decides whether or not to perform the second task processing and generates the parameter using the image recognition result from the first task processing for each image acquired by each of the plurality of image capturing sections mounted on the moving object.

14. The information processing apparatus according to claim 7, wherein
the image capturing section is a stereo camera or a monocular camera.

15. The information processing apparatus according to claim 7, wherein
the processing section performs the second task on the image using the neural network of the second task configured by using the parameter generated, and
further includes a presentation control section that controls a presentation section that provides assistance to an operator of the moving object based on a recognition result of the second task.

16. The information processing apparatus according to claim 15, wherein
one or more selected from a display section, a light emission section, and a sound output section as the presentation section is mounted on the moving object, and
the presentation control section controls at least one of display control of the display section, lighting control of the light emission section, and sound output control of the sound output section.

17. The information processing apparatus according to claim 7, wherein
the moving object is a moving object capable of moving autonomously, and
the processing section performs the second task on the image using the neural network of the second task configured by using the parameter generated, and
further includes a planning section that plans a travel and an action of the moving object based on the recognition result of the second task.

18. The information processing apparatus according to claim 1, wherein
the recognition target is an image,
the first task is the semantic segmentation, and
the second task includes one or more selected from the object detection, the motion detection, the distance detection, normal estimation, attitude estimation, and trajectory estimation.

19. An information processing method performed by an information processing apparatus, comprising:
processing a first task for a recognition target, and
deciding whether or not to perform a second task that shares a feature extraction with the first task using a recognition result of the recognition target from the first task processing.

20. A program that causes an information processing apparatus to perform,
a step of processing a first task for a recognition target, and
a step of deciding whether or not to perform a second task that shares a feature extraction with the first task using a recognition result of the recognition target from the first task processing.
